(19) United States
(12) Patent Application Publication
(10) Pub. No.: US 2026/0089502 A1
(43) Pub. Date: Mar. 26, 2026

(54) COMPUTER-READABLE STORAGE MEDIUM STORING A PROGRAM, INFORMATION PROCESSING APPARATUS, AND METHOD OF CONTROLLING INFORMATION PROCESSING APPARATUS

(71) Applicant: CANON KABUSHIKI KAISHA, Tokyo (JP)

(72) Inventor: HIROYUKI UCHIDA, Chiba (JP)

(21) Appl. No.: 19/335,303

(22) Filed: Sep. 22, 2025

(30) Foreign Application Priority Data
Sep. 26, 2024 (JP) 2024-167828

(51) Int. Cl. H04W 12/06; H04W 76/10

(52) U.S. Cl. CPC H04W 12/06; H04W 76/10

(57) ABSTRACT

An information processing apparatus including: an obtaining unit configured to obtain first connection information for connecting to an external first access point different from the information processing apparatus; a first determining unit configured to, in a case where the first connection information is obtained by the obtaining unit and an authentication method of the first access point is a predetermined authentication method, determine whether the information processing apparatus has previously connected to an access point that uses the predetermined authentication method; and a first attempting unit configured to, in a case where the first determining unit has determined that the information processing apparatus has previously connected to an access point that uses the predetermined authentication method, attempt a connection between the information processing apparatus and the first access point based on the first connection information obtained by the obtaining unit.

### BACKGROUND

### Field of the Technology

The present disclosure relates to a computer-readable storage medium storing a program, an information processing apparatus, and a method of controlling an information processing apparatus.

### Description of the Related Art

Conventional techniques are known in which an information processing apparatus such as a smartphone transmits configuration information (setting information) for connecting to an access point (AP) to a communication apparatus such as a printer and connects the communication apparatus to the AP. Japanese Patent Laid-Open No. 2023-38263 discloses a configuration in which an information processing apparatus attempts to connect to an AP before the information processing apparatus transmits configuration information to the communication apparatus in order to confirm whether the configuration information for connecting to the AP is correct.

### SUMMARY

The present disclosure provides a technique for an information processing apparatus to appropriately perform processing pertaining to connection information for an AP.

The present disclosure in one aspect provides a non-transitory computer-readable storage medium storing a program configured to cause a computer of an information processing apparatus to function as: an obtaining unit configured to obtain first connection information for connecting to an external first access point different from the information processing apparatus; a first determining unit configured to, in a case where the first connection information is obtained by the obtaining unit and an authentication method of the first access point is a predetermined authentication method, determine whether the information processing apparatus has previously connected to an access point that uses the predetermined authentication method; and a first attempting unit configured to, in a case where the first determining unit has determined that the information processing apparatus has previously connected to an access point that uses the predetermined authentication method, attempt a connection between the information processing apparatus and the first access point based on the first connection information obtained by the obtaining unit.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating an example of the configuration of a communication system.

FIG. 2 is a diagram illustrating an example of the hardware configurations of a terminal apparatus and a communication apparatus.

FIG. 3 is a flowchart illustrating processing executed by the terminal apparatus.

FIG. 4 is a flowchart illustrating processing executed by the terminal apparatus.

FIG. 5 is a flowchart illustrating processing executed by the terminal apparatus.

FIG. 6 is an example of a screen displayed by the terminal apparatus.

FIG. 7 is a flowchart illustrating processing executed by the terminal apparatus.

FIG. 8 is a flowchart illustrating processing executed by the communication apparatus.

FIGS. 9A and 9B are diagrams illustrating screens displayed by the terminal apparatus.

FIGS. 10A to 10E are diagrams illustrating screens displayed by the terminal apparatus.

FIG. 11 is a diagram illustrating a screen displayed by the terminal apparatus.

FIG. 12 is a flowchart illustrating processing executed by the terminal apparatus.

FIGS. 13A and 13B are diagrams illustrating screens displayed by the terminal apparatus.

FIG. 14 is a flowchart illustrating processing executed by the terminal apparatus.

FIGS. 15A and 15B are flowcharts illustrating processing executed by the terminal apparatus.

FIG. 16 is a flowchart illustrating processing executed by the terminal apparatus.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

Incidentally, when an information processing apparatus attempts to connect to an AP, if the information processing apparatus does not support the authentication method of the AP, the connection to the AP will fail even if connection information for connecting to the AP, such as a password or the like, is correct. To avoid this, if, for example, the authentication method of the AP is a predetermined authentication method, it is assumed that the information processing apparatus will not attempt to connect to the AP and will transmit the connection information to the communication apparatus. In such a case, if the connection information is incorrect, the communication apparatus will fail to connect to the AP, and the user will therefore need to perform the operations again. What is needed, therefore, is a technique for an information processing apparatus to appropriately perform processing pertaining to connection information for an AP.

### Embodiment

An information processing apparatus and a communication apparatus included in a communication system according to the present embodiment will be described hereinafter. The present embodiment will describe a smartphone as an example of the information processing apparatus, but the information processing apparatus is not limited thereto, and any of a variety of devices, such as a terminal apparatus, a laptop PC, a tablet terminal, a Personal Digital Assistant (PDA), a digital camera, or the like, may be applied thereto. The present embodiment will also describe a printer as an example of the communication apparatus, but the communication apparatus is not limited thereto, and any of a variety of devices can be applied as long as the device is capable of communicating wirelessly with the information processing apparatus. For example, if the device is a printer, the printer may be an ink jet printer, a full-color laser beam printer, a black and white printer, or the like. However, the device is not limited to a printer, and can be applied in a copier, a facsimile device, a terminal apparatus, a smartphone, a laptop PC, a tablet terminal, a PDA, a digital camera, a music playback device, a television, a smart speaker, or the like as well. The device can also be a multifunction peripheral provided with a plurality of functions, such as a copying function, a fax function, a printing function, and the like.

A system configuration for realizing the present embodiment will be described first.

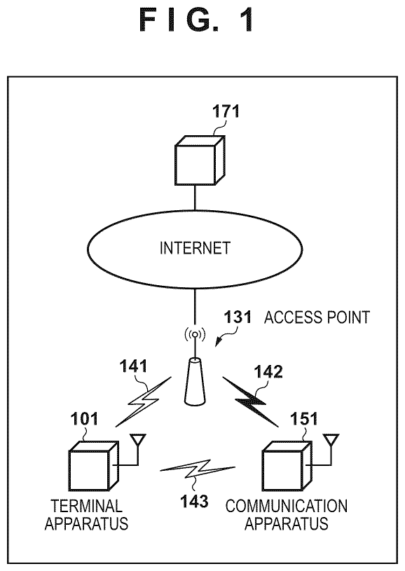

FIG. 1 is a diagram illustrating an example of the configuration of the communication system according to the present embodiment. This system includes a communication apparatus 151, a terminal apparatus 101, an access point (AP) 131, and an external server 171.

The terminal apparatus 101 is the information processing apparatus according to the present embodiment. The communication apparatus 151 is the communication apparatus according to the present embodiment. The AP 131 is an external device outside the terminal apparatus 101 and outside the communication apparatus 151. The external server 171 is a server that can provide services over the Internet to devices connected to the AP 131.

A Local Area Network (LAN) formed by the AP 131 includes the AP 131, the communication apparatus 151, and the terminal apparatus 101. On the other hand, a Wide Area Network (WAN) includes the AP 131 and the external server 171.

In the present embodiment, when an infrastructure connection (described later) is established, the terminal apparatus 101 can communicate with the communication apparatus 151 via the AP 131. Furthermore, when a direct connection (described later) is established, the terminal apparatus 101 can communicate directly with the communication apparatus 151 without going through the AP 131. Note that in the following, a “connection with an AP” corresponds to a connection to a network formed by the AP. Note that the AP may be capable of forming a plurality of networks simultaneously, and in such a case, the “connection with the AP” may be a connection to any one of the plurality of networks formed by the AP.

The present embodiment assumes that a connection 141 between the terminal apparatus 101 and the AP 131 and a connection 142 between the communication apparatus 151 and the AP 131 are connections using communication methods based on an Institute of Electrical and Electronics Engineers (IEEE) 802.11 series standard. The communication method based on the IEEE 802.11 series standard is specifically Wireless Fidelity (Wi-Fi) (registered trademark). A connection 143 between the terminal apparatus 101 and the communication apparatus 151 is assumed to be Wi-Fi or Bluetooth (registered trademark) Low Energy (BLE). Note that the communication methods used for the connections are not limited to these methods, and may be, for example, Bluetooth Classic, Wi-Fi Aware, Near Field Communication (NFC), or the like. The AP 131 and the external server 171 can communicate over the Internet, and in a state where the AP 131 is connected to the Internet, devices connected to the AP 131 (the terminal apparatus 101, the communication apparatus 151, and the like) can also use the Internet. Note that the connection 141 between the terminal apparatus 101 and the AP 131 and the connection 142 between the communication apparatus 151 and the AP 131 may be wired LAN connections.

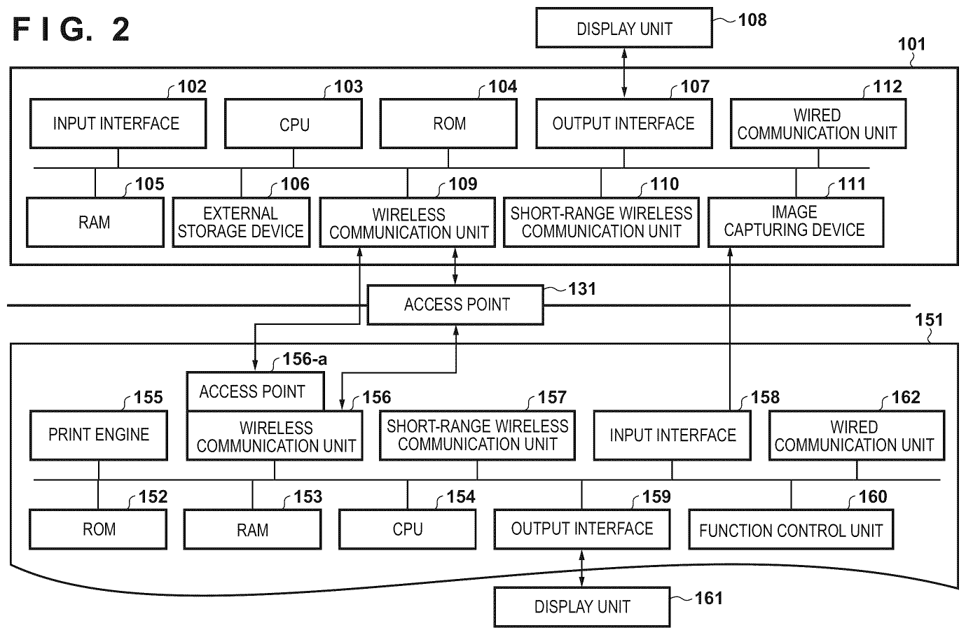

The configuration of the information processing apparatus according to the present embodiment, and the communication apparatus capable of communicating with the information processing apparatus according to the present embodiment, will be described next with reference to the block diagram in FIG. 2. Although the present embodiment will describe the following configuration as an example, the present embodiment can be applied in any apparatus capable of communicating with the communication apparatus, and the functions are not particularly limited to those illustrated here.

The terminal apparatus 101 includes an input interface 102, a CPU 103, a ROM 104, a RAM 105, an external storage device 106, an output interface 107, a display unit 108, a wireless communication unit 109, a short-range wireless communication unit 110, an image capturing device 111, a wired communication unit 112, and the like. A computer of the terminal apparatus 101 is constituted by the CPU 103, the ROM 104, the RAM 105, and the like. Although the terminal apparatus 101 is assumed to be a device such as a smartphone, the terminal apparatus 101 is not limited to a smartphone.

The input interface 102 is an interface for accepting data inputs, operational instructions, and the like from a user, and is constituted by a physical keyboard, buttons, a touch panel, or the like. Note that the output interface 107 (described later) and the input interface 102 may be implemented by the same configuration, with that configuration both outputting screens and accepting operations from the user.

The CPU 103 is a system control unit, and controls the terminal apparatus 101 as a whole.

The ROM 104 stores fixed data such as control programs executed by the CPU 103, data tables, an operating system (“OS”, hereinafter) program, and the like. In the present embodiment, the control programs stored in the ROM 104 perform software execution control, such as scheduling, task switching, interrupt processing, and the like, under the management of the embedded OS stored in the ROM 104. In the present embodiment, the ROM 104 stores a setup application program (“setup app” hereinafter). The setup app is installed in the terminal apparatus 101 from the outside by a store application program, for example. The setup app is an app provided by the vendor of the communication apparatus 151. Note that the setup app may have other functions aside from the network setup function of the communication apparatus 151. Specifically, the other functions include a function for performing setup other than the network setup of the communication apparatus 151, a function for transmitting a print job to cause the communication apparatus 151 to execute a print, a function for transmitting a scan job to cause the communication apparatus 151 to execute a scan, and the like. In the present embodiment, the OS is Windows, for example. In other words, the OS is an OS that manages wireless profiles (described later) that include information such as an encryption method, an authentication method, and the like.

The RAM 105 is constituted by Static Random Access Memory (SRAM) or the like that requires a backup power source. Note that the RAM 105 holds data in a primary battery for data backup (not shown), and can therefore store important data such as program control variables in a non-volatile state. A memory area for storing configuration information of the terminal apparatus 101, management data of the terminal apparatus 101, and the like is also provided in the RAM 105. The RAM 105 is used as a main memory and a working memory for the CPU 103.

Additionally, the external storage device 106 includes various types of programs, such as a print information generation program that generates print information which can be interpreted by the communication apparatus 151, an information transmission/reception control program that transmits and receives information to and from the connected communication apparatus 151 through the wireless communication unit 109, and the like. The external storage device 106 also stores various types of information used by these programs, image data obtained from other information processing apparatuses, the Internet, and the like.

The output interface 107 is an interface for controlling the display unit 108 to display data, make notifications on the state of the terminal apparatus 101, and the like.

The display unit 108 is constituted by light-emitting diodes (LEDs), a liquid crystal display (LCD), or the like, and displays data, makes notifications regarding the state of the terminal apparatus 101, and the like. Note that inputs from the user can be accepted through the display unit 108 by providing, in the display unit 108, a software keyboard including numerical value input keys, a mode setting key, a confirm key, a cancel key, a power key, and the like.

The wireless communication unit 109 is wirelessly connected to devices such as the communication apparatus 151, the AP 131, and the like, and is configured to communicate data. For example, the wireless communication unit 109 may communicate directly with the communication apparatus 151 wirelessly, or may communicate via the AP 131 outside the terminal apparatus 101, the communication apparatus 151, and the like. Although the present embodiment assumes that Wi-Fi, which is a communication method based on the IEEE 802.11 standard, is used as the wireless communication method of the wireless communication unit 109, Bluetooth Classic or the like may be used instead. The present embodiment also assumes that the wireless LAN is a network using Wi-Fi. A device such as a wireless LAN router or the like can be given as an example of the AP 131. Note that a method in which the terminal apparatus 101 and the communication apparatus 151 connect directly without going through an external AP will be referred to as a “direct connection method” in the present embodiment. A method in which the terminal apparatus 101 and the communication apparatus 151 connect via an external AP will be referred to as an “infrastructure connection method”.

The short-range wireless communication unit 110 is an element for communicating data with devices such as the communication apparatus 151, and communicates using a communication method different from that of the wireless communication unit 109. The short-range wireless communication unit 110 can connect to a short-range wireless communication unit 157 in the communication apparatus 151. Note that BLE, Bluetooth Classic, Wi-Fi Aware, NFC, and the like can be given as examples of the communication method of the short-range wireless communication unit 110.

The image capturing device 111 is a device that converts images captured by an image sensor into digital data. The digital data is initially stored in the RAM 105. The digital data is then converted to a predetermined image format by a program executed by the CPU 103, and the resulting data is stored in the external storage device 106 as image data.

The wired communication unit 112 is connected over wires to devices such as the communication apparatus 151, the AP 131, and the like, and is configured to communicate data. For example, the wired communication unit 112 communicates over the wired LAN. The present embodiment assumes that the wired LAN communicates according to the Ethernet standard. Note, however, that the configuration is not limited thereto, and the wired communication unit 112 may communicate over a Universal Serial Bus (USB) cable, for example.

The communication apparatus 151 includes a ROM 152, a RAM 153, a CPU 154, a print engine 155, a wireless communication unit 156, the short-range wireless communication unit 157, an input interface 158, an output interface 159, a function control unit 160, a display unit 161, a wired communication unit 162, and the like. A computer of the terminal apparatus 101 is constituted by the ROM 152, the RAM 153, the CPU 154, and the like.

The wireless communication unit 156 is wirelessly connected to devices such as the terminal apparatus 101, the AP 131, and the like, and is configured to communicate data. Although the present embodiment assumes that Wi-Fi is used as the wireless communication method of the wireless communication unit 156, the method is not limited to Wi-Fi. As an AP internal to the communication apparatus 151, the wireless communication unit 156 includes an AP 156-a for connecting to devices such as the terminal apparatus 101. The AP is capable of connecting to the wireless communication unit 109 of the terminal apparatus 101. Note that the wireless communication unit 156 may communicate directly with the terminal apparatus 101 via the AP 156-a, or may communicate with the terminal apparatus 101 via the AP 131. Additionally, the AP 156-a may be hardware that functions as an AP, or the wireless communication unit 156 may operate as an AP 156-a using software for functioning as an AP. The AP within the communication apparatus 151 may also be constituted by a plurality of APs having different SSIDs and passwords. The present embodiment assumes that the AP within the communication apparatus 151 includes at least a connection configuration AP (described later).

The RAM 153 is constituted by DRAM or the like that requires a backup power source. Note that the RAM 153 holds data by being supplied with power for data backup (not shown), and can therefore store important data such as program control variables in a non-volatile state. The RAM 153 is also used as a main memory and working memory for the CPU 154, and includes a reception buffer for temporarily storing print information received from the terminal apparatus 101 or the like, stores various types of information, and the like.

The ROM 152 stores fixed data such as control programs executed by the CPU 154, data tables, OS programs, and the like. In the present embodiment, the control programs stored in the ROM 152 perform software execution control, such as scheduling, task switching, interrupt processing, and the like, under the management of the embedded OS stored in the ROM 152. A memory area for storing data required to be held even when power is not supplied, such as configuration information of the communication apparatus 151, management data of the communication apparatus 151, and the like, is also provided in the ROM 152.

The CPU 154 is a system control unit, and controls the communication apparatus 151 as a whole.

On the basis of the information stored in the RAM 153 and a print job received from the terminal apparatus 101 or the like, the print engine 155 forms an image on a recording medium such as paper using a recording agent such as ink, and the result of the printing is output. At this time, the print job transmitted from the terminal apparatus 101 or the like involves transmitting a large amount of data and requires high-speed communication, and is therefore received via the wireless communication unit 156, which is capable of faster communication than the short-range wireless communication unit 157.

The short-range wireless communication unit 157 is an element for communicating with devices such as the terminal apparatus 101 using a short-range wireless communication method. Note that BLE, Bluetooth Classic, Wi-Fi Aware, and the like can be given as examples of the communication method of the short-range wireless communication unit 157.

The input interface 158 is an interface for accepting data inputs, operational instructions, and the like from a user, and is constituted by a physical keyboard, buttons, a touch panel, or the like. Note that the output interface 159 (described later) and the input interface 158 may be implemented by the same configuration, with that configuration both outputting screens and accepting operations from the user. The output interface 159 is an interface for controlling the display unit 161 to display data, make notifications of the state of the communication apparatus 151, and the like.

The function control unit 160 manages whether to operate the functions of the communication apparatus 151 simultaneously.

The display unit 161 is constituted by light-emitting diodes (LEDs), a liquid crystal display (LCD), or the like, and displays data, makes notifications regarding the state of the communication apparatus 151, and the like. Note that inputs from the user can be accepted through the display unit 161 by providing, in the display unit 161, a software keyboard including numerical value input keys, a mode setting key, a confirm key, a cancel key, a power key, and the like.

The wired communication unit 162 is connected over wires to devices such as the terminal apparatus 101, the AP 131, and the like, and is configured to communicate data. For example, the wired communication unit 162 communicates over the wired LAN. Note, however, that the configuration is not limited thereto, and the communication may be performed over a USB cable, for example.

### Connection Method

“Direct connection” refers to a form in which devices connect directly to each other (i.e., peer-to-peer) wirelessly, without going through an external device such as the AP 131 or the like. Direct connection will also be referred to as a “peer-to-peer connection” (“P2P connection”). The communication apparatus 151 can operate in a mode for communicating over a direct connection (a “direct connection mode”) as one connection mode. Wi-Fi communication includes a plurality of modes for communicating over a direct connection, such as a software AP mode, a Wi-Fi Direct (WFD) mode, and the like.

A mode in which a direct connection is made through WFD is called “WFD mode”. WFD is a standard developed by the Wi-Fi Alliance and is included in the IEEE 802.11 series communication standard. In WFD mode, a device to serve as a communication partner is searched for using a device search command, after which the roles of P2P group owner (GO) and P2P client are determined, and the remaining wireless connections are processed. “Group owner” corresponds to the parent station (parent device) in Wi-Fi, and the client corresponds to a child station (child device) in Wi-Fi. This role determination corresponds to GO Negotiation in P2P, for example. In WFD mode, the communication apparatus 151 is neither the parent station nor the child station before the roles have been determined. Specifically, one device among the devices that are to communicate issues the device search command, and searches for a device to connect to in WFD mode. When the other device, which is to serve as the communication partner, is discovered, the devices confirm information pertaining to the services and functions those respective devices can supply. Note that the confirmation of the device supply information is optional, and is not required. The device supply information confirmation phase corresponds to Provision Discovery in P2P, for example. Next, which device will serve as the P2P client and which will serve as the P2P group owner is determined by confirming this device supply information with each other. Once the client and the group owner have been determined, the devices exchange parameters for communicating through WFD. The remaining wireless connections and IP connections are processed between the P2P client and group owner on the basis of the exchanged parameters. Note that in WFD mode, the communication apparatus 151 may skip the GO Negotiation described above, and the communication apparatus 151 may always operate as the GO. In other words, the communication apparatus 151 may operate in Autonomous GO mode, which is a WFD mode. A state in which the communication apparatus 151 is operating in WFD mode is a state in which, for example, a connection using WFD is not established but the communication apparatus 151 is operating as the GO, a connection using WFD is established and the communication apparatus 151 is operating as the GO, or the like.

In the software AP mode, among the communicating devices (e.g., the terminal apparatus 101 and the communication apparatus 151), one of the devices (e.g., the terminal apparatus 101) functions as a client that has a role of requesting various types of services. The other device provides a Wi-Fi AP function by configuring software. The software AP corresponds to the parent station in Wi-Fi, and the client corresponds to the child station in Wi-Fi. In software AP mode, the client uses the device search command to search for a device that will serve as a software AP. Once a software AP is discovered, the remaining wireless connection processing (the establishment of a wireless connection and the like) is performed between the client and the software AP, after which IP connection processing (IP address allocation and the like) is performed. Note that commands, parameters, and the like sent and received when establishing a wireless connection between the client and the software AP may be any specified by the Wi-Fi standard, and will therefore not be described here.

In the present embodiment, when establishing and maintaining a direct connection, the communication apparatus 151 operates as the parent station in the network to which the communication apparatus 151 belongs. Note that “parent station” refers to a device that constructs a wireless network, and is a device that provides child stations with the parameters used to connect to the wireless network. The parameters used to connect to the wireless network are parameters pertaining to a channel used by the parent station, for example. By receiving these parameters, a child station connects to the wireless network constructed by the parent station using the channel used by the parent station. In direct connection mode, the communication apparatus 151 operates as the parent station, and the communication apparatus 151 can therefore determine which frequency band and which channel to use in the communication performed in direct connection mode. In the present embodiment, the communication apparatus 151 is assumed to use a channel corresponding to the 2.4 GHz frequency band and a channel corresponding to the 5 GHz frequency band in the communication performed in direct connection mode. The user can then set the frequency band to be used (i.e., the frequency band channel to be used) as desired by making a setting in a screen (not shown). In other words, if 2.4 GHz is selected on the screen, the communication apparatus 151 uses a channel corresponding to the 2.4 GHz frequency band in the communication performed in direct connection mode. On the other hand, if 5 GHz is selected on the screen, the communication apparatus 151 uses a channel corresponding to the 5 GHz frequency band in the communication performed in direct connection mode. However, the present embodiment assumes that even if 5 GHz is selected on the screen, the communication apparatus 151 will not use a channel corresponding to a Dynamic Frequency Selection (DFS) band in the 5 GHz frequency band for the communication performed in direct connection mode. In other words, the communication apparatus 151 is assumed to use only channels corresponding to frequency bands outside the DFS band in the 5 GHz frequency band for the communication performed in direct connection mode. If, when using a channel corresponding to the DFS band, a radar wave is detected in the frequency band corresponding to that channel, it is necessary to change the channel currently being used. A frequency band in which the channel may be changed in response to a radar wave being detected is called a Dynamic Frequency Selection (DFS) band. Note, however, that it may be possible to use a channel corresponding to the DFS band among the 5 GHz frequency band for communication performed in direct connection mode when, for example, using a wireless chip that supports the DFS function. The channel determined as the channel to be used in the direct connection mode is used in communication over the direct connection. The channel is furthermore used for transmitting a beacon signal as a parent station, transmitting a response to a received command, and the like. In other words, the channel is used not only for communication processing in a direct connection mode in a state where a direct connection is established, but also for communication processing in a direct connection mode in a state where a direct connection is not established.

Although the foregoing describes a configuration in which the user can set whether to use a channel corresponding to the 2.4 GHz frequency band or a channel corresponding to the 5 GHz frequency band in the direct connection mode, the configuration is not limited thereto. The configuration may be such that the user can set a specific channel number to be used in the direct connection mode by accepting a designation of the channel number from the user. The channel used in the direct connection mode may be set in advance in the communication apparatus 151, rather than being set as desired by the user.

Although the foregoing describes a configuration in which the communication apparatus 151 can use the 2.4 GHz frequency band and the 5 GHz frequency band, the configuration is not limited thereto. Other frequency bands may be used, and other frequency bands may be used in the processing in which the 2.4 GHz frequency band or the 5 GHz frequency band are used in the present embodiment. For example, in the IEEE 802.11ad standard, a frequency band of 60 GHz can be used, and thus 60 GHz may be used as the stated other frequency band.

### Infrastructure Connection Method

An “infrastructure connection” is a type of connection for devices that are to communicate (e.g., the terminal apparatus 101 and the communication apparatus 151) to connect to an AP (e.g., the AP 131) handling the network of those devices, and communicate with each other via the AP. The communication apparatus 151 is also capable of operating in a mode for communicating over an infrastructure connection (infrastructure connection mode) as one connection mode.

In an infrastructure connection, each device uses a device search command to search for an AP. Once an AP is discovered, the remaining wireless connection processing (the establishment of a wireless connection and the like) is performed between the device and the AP, after which IP connection processing (the allocation of IP addresses and the like) is performed. Note that commands, parameters, and the like sent and received when establishing a wireless connection between the devices and the AP may be any specified by the Wi-Fi standard, and will therefore not be described here.

In the present embodiment, when the communication apparatus 151 operates over an infrastructure connection, the AP 131 operates as the parent station and the communication apparatus 151 operates as a child device. In other words, in the present embodiment, “infrastructure connection” refers to a connection between the communication apparatus 151, which operates as a child device, and a device operating as a parent device. When the communication apparatus 151 has established an infrastructure connection and the terminal apparatus 101 has also established an infrastructure connection with the AP 131, the communication apparatus 151 and the terminal apparatus 101 can communicate via the AP 131. The channel used for communication in the infrastructure connection is determined by the AP 131, and thus the communication apparatus 151 communicates over the infrastructure connection using the channel determined by the AP 131. In the present embodiment, the communication apparatus 151 is assumed to use a channel corresponding to the 2.4 GHz frequency band and a channel corresponding to the 5 GHz frequency band in the communication performed in the infrastructure connection. Note that the communication apparatus 151 can also use a channel corresponding to the DFS band and the 5 GHz frequency band in the communication performed in the infrastructure connection. Note also that to communicate via the communication apparatus 151 and the AP 131, it is necessary for the terminal apparatus 101 to recognize that the communication apparatus 151 belongs to the network formed by the AP 131 and to which the terminal apparatus 101 belongs.

### Simultaneous Operations

The communication apparatus 151 according to the present embodiment is assumed to be capable of executing infrastructure mode operations and direct connection mode operations simultaneously (in parallel). Accordingly, the communication apparatus 151 can maintain a connection for communicating in the infrastructure mode and a connection for communicating in the direct connection mode simultaneously (in parallel). In other words, the communication apparatus 151 can establish a Wi-Fi connection in which the communication apparatus 151 is the child device and a Wi-Fi connection in which the communication apparatus 151 is the parent device in parallel. Establishing an infrastructure connection and a direct connection simultaneously (in parallel) and operating simultaneously (in parallel) over the infrastructure connection and the direct connection will be called “simultaneous operation” hereinafter. In other words, simultaneous operation is operation in which the communication apparatus 151 performs operations as a parent device (a Group Owner or an AP) and operations as a child device in parallel.

Infrastructure mode communication and direct connection mode communication are performed using a specific frequency band (a specific channel). Accordingly, in both the infrastructure mode communication and the direct connection mode communication, before communication is started, it is necessary to first determine the channel to be used for the communication and connection between the respective devices. Note that in a configuration where a plurality of channels are simultaneously assigned to a single wireless IC chip for communication, the configuration of each apparatus that performs communication, the processing executed by each apparatus, and the like become complicated. Accordingly, when the communication apparatus 151 performs simultaneous operation, it is desirable to use a common channel in the communication in each mode. In other words, it is desirable for the communication apparatus 151 to use only one channel even when performing simultaneous operation. Accordingly, the present embodiment assumes that the wireless communication unit 156 has only one wireless IC chip that realizes communication through a predetermined channel, and that the communication apparatus 151 does not communicate using a plurality of channels simultaneously.

### Connection Configuration Mode

The communication apparatus 151 can operate in a connection configuration mode. The trigger for the communication apparatus 151 to start operating in the connection configuration mode may be, for example, a user pressing a connection configuration mode button, or the communication apparatus 151 being started (powered on) for the first time after being shipped. The connection configuration mode button may be a physical button included in the communication apparatus 151, or may be a software button displayed on the display unit 161 by the communication apparatus 151.

When the communication apparatus 151 starts operating in the connection configuration mode, both Wi-Fi communication and BLE communication are enabled. Specifically, the communication apparatus 151 enables an internal AP of the communication apparatus 151 (a connection configuration AP), which is specifically for the connection configuration mode, as processing for enabling Wi-Fi communication. This enables the communication apparatus 151 to establish a direct connection with the terminal apparatus 101 using Wi-Fi. Connection information (an SSID, a password, or the like) for connecting to the connection configuration AP is assumed to be held in advance in the setup app installed in the terminal apparatus 101, and the terminal apparatus 101 is assumed to have recognized the connection information for connecting to the connection configuration AP. Note that an encryption method need not be set for the connection configuration AP, and thus a password may be unnecessary for connecting to the AP. Accordingly, unlike the connection information of the AP enabled in the direct connection mode, it is assumed that the connection information for connecting to the connection configuration AP cannot be changed by the user as desired. Note that in the connection configuration mode, the communication apparatus 151 may connect to the terminal apparatus 101 using Wi-Fi Direct (WFD) instead of normal Wi-Fi. In other words, the communication apparatus 151 may operate as the Group Owner and receive configuration commands from the terminal apparatus 101 through communication using WFD.

### Wireless Profile

The wireless profile is information stored and managed by the OS of the terminal apparatus 101, and is information including connection information of APs to which the terminal apparatus 101 has been connected. The wireless profile is used for a reconnection function in which, for example, when a connection between the terminal apparatus 101 and an AP is cut off, the OS automatically re-establishes the connection.

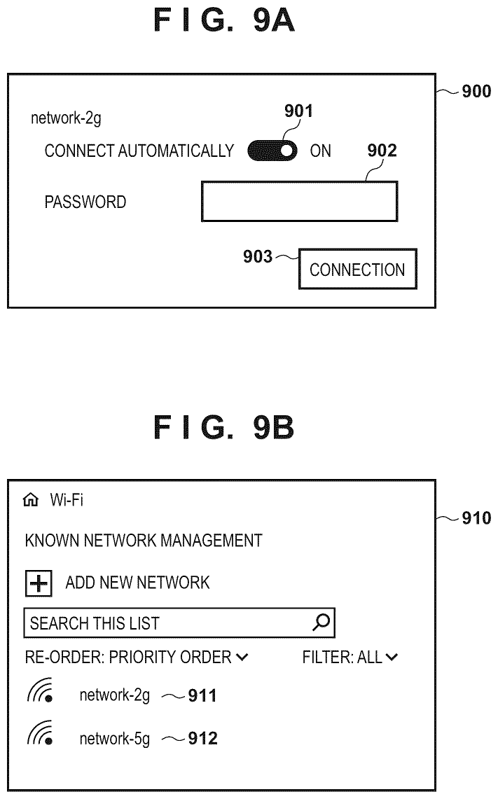

FIG. 9A illustrates a connection screen 900, which is a screen displayed by the OS and is a screen for the terminal apparatus 101 to connect to an AP. The connection screen 900 is assumed to be a screen for connecting to the AP 131 having an SSID displayed on the screen 900. The connection screen 900 includes a region 901 for setting whether to enable the reconnection function in the connection with the AP 131, a region 902 for accepting an input of a password for connecting to the AP 131, and a region 903 for attempting to establish a connection between the AP 131 and the terminal apparatus 101 using the input password. When the reconnection function is enabled in the region 901, if the connection between the terminal apparatus 101 and the AP 131 is cut off, the OS automatically re-establishes the connection. On the other hand, when the reconnection function is disabled in the region 901, even if the connection between the terminal apparatus 101 and the AP 131 is cut off, the OS does not automatically re-establish the connection. When the connection between the AP 131 and the terminal apparatus 101 is successfully established as a result of the region 903 being pressed, the OS saves the connection information (the SSID, the password, and the like) of the AP 131 as a wireless profile. However, in specific types of OSs and specific versions of OSs, when the reconnection function is disabled, the connection information of the AP 131 is not saved as a wireless profile even if the connection between the AP 131 and the terminal apparatus 101 is successfully established.

FIG. 9B illustrates a wireless profile screen 910, which is a screen displayed by the OS and is a screen for indicating the stored wireless profiles. The wireless profile screen 910 is an example of a screen displayed when the OS stores two wireless profiles. Wireless profiles having higher priorities are displayed higher in the wireless profile screen 910. A high-priority wireless profile is a wireless profile that is used with higher priority in a state where a connection between the terminal apparatus 101 and the AP is not established. A region 911 is a region where the first wireless profile having a higher priority is indicated by the SSID, and a region 912 is a region where the second wireless profile having a lower priority is indicated by the SSID. Note that by performing a predetermined operation on the region 911, the region 912, and the like it is possible to delete the wireless profile corresponding to the region where the predetermined operation was performed from the terminal apparatus 101.

### Processing Performed by Terminal Apparatus 101 and Communication Apparatus 151

In the present embodiment, the setup app can execute network setup of the communication apparatus 151 via the wireless connection between the terminal apparatus 101 and the communication apparatus 151 operating in the connection configuration mode (“first setup” hereinafter). In other words, the first setup is a setup method for connecting the communication apparatus 151 and the AP by the setup app transmitting configuration information (setting information) to the communication apparatus 151 from the terminal apparatus 101 through wireless communication. Note that the configuration information includes a password for connecting to the AP. For example, there are cases where the wireless profile corresponding to a predetermined AP that is the connection partner of the communication apparatus 151 is saved in the terminal apparatus 101 in advance before the setup app accepts a predetermined operation for network setup (a predetermined instruction) from the user. In such a case, the setup app can execute the first setup without accepting the input of a password from the user.

Additionally, in the present embodiment, the communication apparatus 151 can connect to the AP through a method other than the first setup. Second setup and third setup, which are methods other than the first setup, are instances of network setup performed without the setup app transmitting configuration information from the terminal apparatus 101 to the communication apparatus 151 through wireless communication. Specifically, for example, the second setup is network setup using push-button Wi-Fi Protected Setup (WPS). Note that the second setup may be network setup using PIN code-based WPS. The second setup may also be network setup other than WPS, such as AOSS, Easy Wireless Start, or the like. Additionally, the second setup may be network setup performed by establishing a connection between an AP, among APs discovered by the communication apparatus 151, that has been selected by the user in an operation performed on the communication apparatus 151, and the communication apparatus 151, over a wireless LAN. The third setup, which is a method other than the first setup, is network setup performed by establishing a connection between the AP and the communication apparatus 151 over a wired LAN. Note that the third setup may be network setup performed by establishing a connection between the terminal apparatus 101 and the communication apparatus 151 over USB. The second setup and the third setup are setup methods that can be executed without the user inputting a password for connecting to the AP in the setup app. For example, there are cases where the wireless profile corresponding to a predetermined AP is not saved in the terminal apparatus 101 in advance before the predetermined instruction is accepted from the user by the setup app. In such a case, the setup app preferably executes predetermined processing for setup other than the first setup. This is because many users feel that the second setup and the third setup are more convenient than the first setup when an operation for inputting a password is involved. Specifically, the predetermined processing is, for example, processing for displaying a selection screen (described later), processing for displaying a guide screen (described later), or the like.

However, there are cases where the predetermined AP does not require a password even if the wireless profile corresponding to the predetermined AP is not saved in the terminal apparatus 101 in advance before the predetermined instruction is accepted from the user by the setup app. In such a case, the setup app can execute the first setup without accepting the input of a password from the user. Nevertheless, there are cases where the wireless profile corresponding to the predetermined AP is not saved in the terminal apparatus 101 in advance before the predetermined instruction is accepted from the user by the setup app, and the predetermined AP does not require a password. In such a case, having the setup app perform the predetermined processing results in a drop in usability.

Accordingly, in the present embodiment, the setup app operates as follows. If the wireless profile corresponding to the predetermined AP is not saved in the terminal apparatus 101 in advance before the predetermined instruction is accepted from the user by the setup app, and the predetermined AP does not require a password, the setup app executes the first setup without executing the predetermined processing. On the other hand, if a wireless profile corresponding to the predetermined AP is not saved in the terminal apparatus 101, and the predetermined AP requires a password, the setup app executes the predetermined processing.

Additionally, as described above, in the first setup according to the present embodiment, communication is performed over the wireless connection between the terminal apparatus 101 and the communication apparatus 151 operating in the connection configuration mode. However, if Internet Protocol version 6 (IPv6) is set in the terminal apparatus 101 as the protocol used by the terminal apparatus 101 for communication, there are cases where the communication cannot be performed. This is because the communication apparatus 151 operating in the connection configuration mode may not be capable of communicating using IPv6. Accordingly, in the present embodiment, if Internet Protocol version 4 (IPv4) is set in the terminal apparatus 101 as the protocol used by the terminal apparatus 101 for communication, the setup app executes the first setup without executing predetermined processing. On the other hand, if IPv6 is set in the terminal apparatus 101 as the protocol used by the terminal apparatus 101 for communication, the setup app executes the predetermined processing. A case where IPv4 is set in the terminal apparatus 101 as the protocol used by the terminal apparatus 101 for communication corresponds to a case where communication by the wireless communication unit 109 using IPv4 is enabled in the terminal apparatus 101. Likewise, a case where IPv6 is set in the terminal apparatus 101 as the protocol used by the terminal apparatus 101 for communication corresponds to a case where communication by the wireless communication unit 109 using IPv6 is enabled in the terminal apparatus 101.

Such a configuration makes it possible to improve the convenience of the setup of the communication apparatus 151.

Additionally, in the first setup, before the terminal apparatus 101 transmits the configuration information to the communication apparatus 151, the terminal apparatus 101 attempts to connect to the AP using connection information such as the password of the AP input by the user. Having the terminal apparatus 101 confirm whether the connection information input by the user is correct in this manner makes it possible to reduce cases where the communication apparatus 151 fails to connect to the AP. However, if the terminal apparatus 101 does not support the authentication method used by the AP selected by the user, the connection to the AP will fail even if the connection information such as the password or the like is correct. To avoid such a situation, if, for example, the authentication method of the AP is a predetermined authentication method, it is assumed that the attempt to connect to the AP will not be made, and the connection information will be transmitted to the communication apparatus 151, regardless of whether the terminal apparatus 101 supports the predetermined authentication method. However, if, when the terminal apparatus 101 does not attempt to connect to the AP, the connection information is incorrect, the communication apparatus 151 will fail to connect to the AP. If the communication apparatus 151 fails to connect to the AP, it is necessary for the user to perform operations such as setting the communication apparatus 151 to a state where the configuration information can be received from the terminal apparatus 101. This reduces the usability. What is needed, therefore, is a technique for the terminal apparatus 101 to appropriately perform processing pertaining to connection information for an AP.

Accordingly, in the present embodiment, the terminal apparatus 101 operates as follows using the setup app. The terminal apparatus 101 obtains the connection information for connecting to the AP selected by the user. When the connection information is obtained and the authentication method of the AP selected by the user is a predetermined authentication method such as WPA3-SAE or the like (described later), the terminal apparatus 101 makes the following determination. Specifically, the terminal apparatus 101 determines whether the terminal apparatus 101 has previously connected to an AP that uses the predetermined authentication method. If the terminal apparatus 101 is determined to have previously connected to an AP that uses the predetermined authentication method, the setup app then attempts to make a connection between the terminal apparatus 101 and the AP selected by the user on the basis of the connection information.

Attempting to connect to the AP when the terminal apparatus 101 supports the predetermined authentication method in this manner makes it possible to prevent the connection to the AP from failing due to the terminal apparatus 101 not supporting the authentication method of the AP. This also makes it possible to prevent situations where configuration information including erroneous connection information is transmitted to the communication apparatus 151 without attempting to connect to the AP regardless of whether the terminal apparatus 101 supports the authentication method of the AP. In other words, the terminal apparatus 101 can appropriately perform processing pertaining to the connection information for an AP. As a result, cases where the communication apparatus 151 fails to connect to the AP can be reduced, and the convenience for the user can be increased.

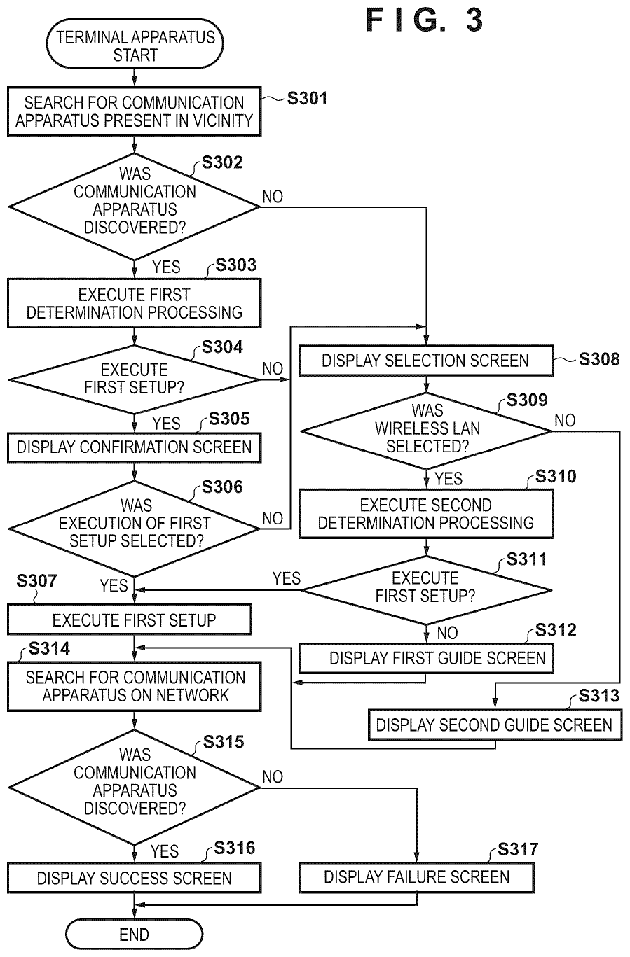

FIG. 3 is a flowchart illustrating network setup of the communication apparatus 151 executed by the terminal apparatus 101. This flowchart is implemented by the CPU 103 reading out a program stored in the ROM 104 into the RAM 105 and executing the program. Note that the present embodiment assumes that the terminal apparatus 101 executes the processing using the setup app. This flowchart is also assumed to be started on the basis of the predetermined operation being performed by the user on a screen displayed by the setup app.

In step S301, the CPU 103 searches for the communication apparatus 151 operating in the connection configuration mode. Specifically, the CPU 103 searches for a beacon that is emitted by the communication apparatus 151 operating in the connection configuration mode, and that includes an SSID corresponding to the connection configuration mode.

In step S302, the CPU 103 determines whether the communication apparatus 151 operating in the connection configuration mode has been discovered through the search performed in step S301. Specifically, the CPU 103 detects beacons emitted by devices around the terminal apparatus 101. The CPU 103 then determines whether there is a beacon, among the detected beacons, that has been emitted by the communication apparatus 151 operating in the connection configuration mode and that includes an SSID corresponding to the connection configuration mode. An “SSID corresponding to the connection configuration mode” is the same SSID as that in the connection information for connecting to the connection configuration AP, held in advance in the setup app. Accordingly, the CPU 103 determines whether there is a beacon, among the beacons emitted by the devices around the terminal apparatus 101, that includes the same SSID as that in the connection information for connecting to the connection configuration AP, held in advance in the setup app. The CPU 103 moves the sequence to step S303 if a determination of “yes” is made, and to step S308 if a determination of “no” is made. Additionally, if a determination of “yes” is made, the CPU 103 specifies the discovered communication apparatus 151 as an apparatus subject to network setup (“target apparatus” hereinafter). Note that if a plurality of communication apparatuses 151 are discovered, the first communication apparatus 151 discovered may be specified as the target apparatus, or a communication apparatus 151 selected by the user from among the plurality of discovered communication apparatuses 151 may be specified as the target apparatus. It is assumed that thereafter, processing for network setup is performed for the communication apparatus 151 specified as the target apparatus.

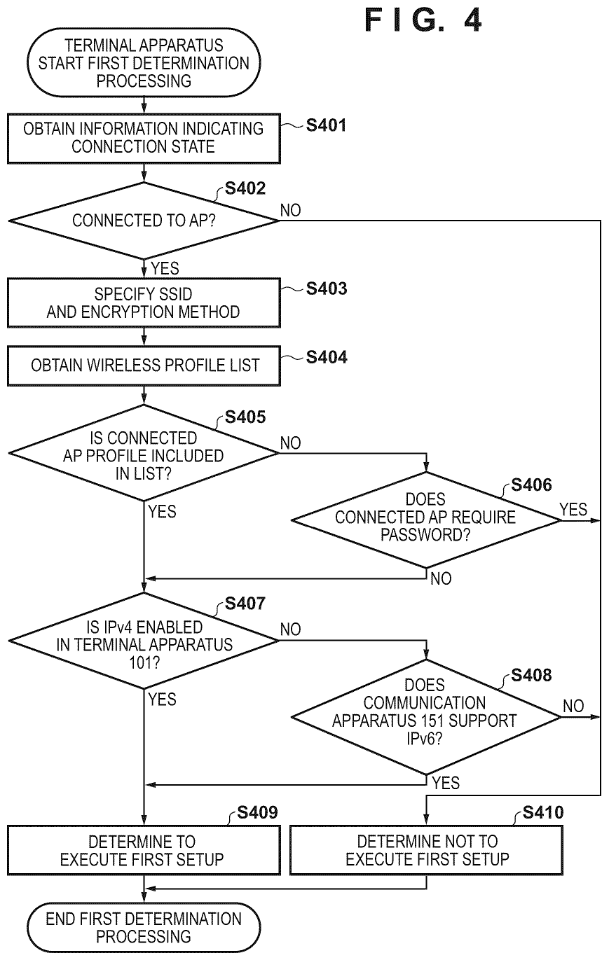

In step S303, the CPU 103 executes first determination processing for determining whether to perform the first setup without executing the predetermined processing described above. This first determination processing will be described later in detail with reference to FIG. 4.

In step S304, the CPU 103 determines, in the first determination processing, whether the first setup has been determined to be performed without executing the predetermined processing. The CPU 103 moves the sequence to step S305 if a determination of “yes” is made, and to step S308 if a determination of “no” is made. If a determination of “yes” is made, the CPU 103 executes the first setup without executing processing pertaining to setup other than the first setup, such as displaying the selection screen, displaying the guide screen, and the like (described later). On the other hand, if a determination of “no” is made, the CPU 103 executes processing pertaining to setup other than the first setup, such as displaying the selection screen, displaying the guide screen, and the like (described later).

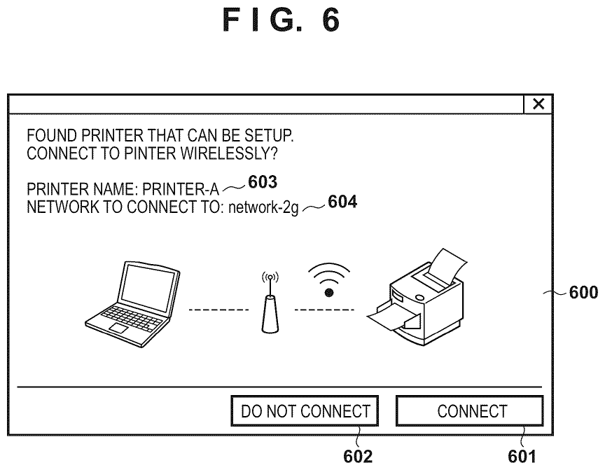

In step S305, the CPU 103 displays, on the display unit 108, a confirmation screen for confirming whether to perform the first setup. A confirmation screen 600 illustrated in FIG. 6 is displayed here, for example. For example, the confirmation screen 600 includes a button 601 for selecting to perform the first setup, and a button 602 for selecting not to perform the first setup. Additionally, for example, the confirmation screen 600 includes a region 603 indicating the name of the communication apparatus 151, and a region 604 indicating the SSID of the network to which the terminal apparatus 101 is currently connected. The name of the communication apparatus 151 is assumed to be included in the beacon obtained from the communication apparatus 151 through the search performed in step S301. The SSID of the network to which the terminal apparatus 101 is currently connected is assumed to be obtained in the first determination processing.

In step S306, the CPU 103 determines whether performing the first setup has been selected in the confirmation screen. Specifically, in this determination, whether the button 601 or the button 602 has been selected is determined. The CPU 103 moves the sequence to step S307 if a determination of “yes” is made, and to step S308 if a determination of “no” is made.

Note that the processing of steps S305 and S306 may be omitted. In other words, if a determination of “yes” is made in step S304, the sequence may move to step S307 without the processing of steps S305 and S306 being executed.

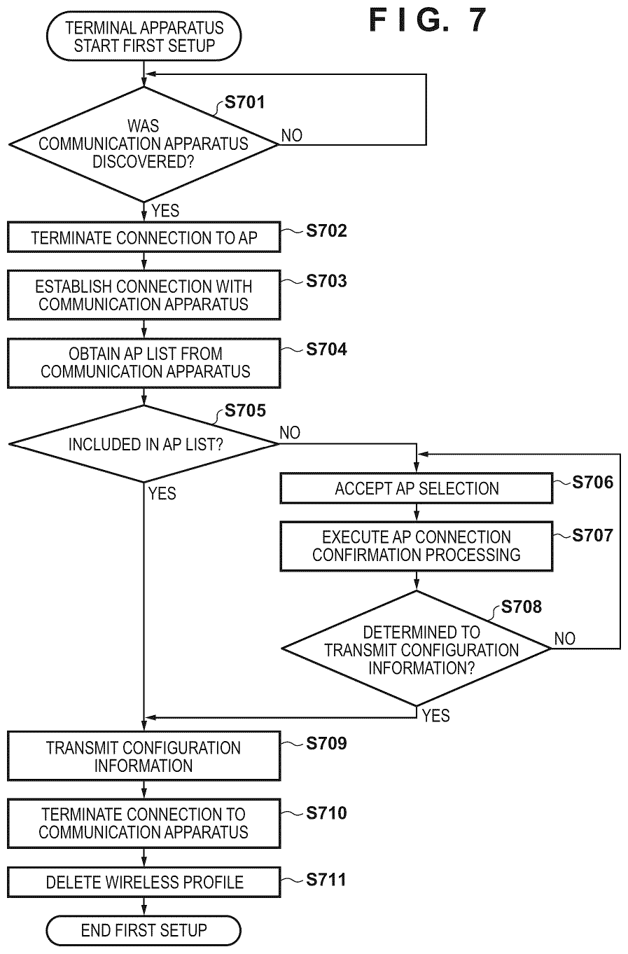

In step S307, the CPU 103 performs the first setup. This processing will be described later in detail with reference to FIG. 7. The sequence then moves to step S314.

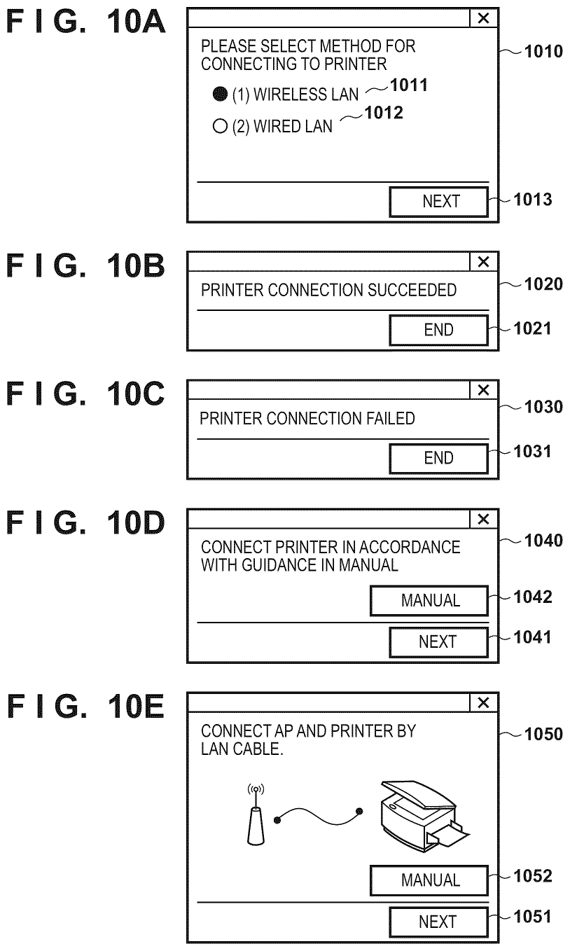

As described above, step S308 is executed when a determination of “no” is made in step S302, when a determination of “no” is made in step S304, or when a determination of “no” is made in step S306. In step S308, the CPU 103 accepts a selection of the method for the connection between the terminal apparatus 101 and the communication apparatus 151 from the user. Here, for example, a selection screen 1010 illustrated in FIG. 10A is displayed on the display unit 108. For example, the selection screen 1010 includes a region 1011 for selecting a connection method using a wireless LAN, a region 1012 for selecting a connection method using a wired LAN, and a button 1013 for displaying a next screen. Note that the network setup for establishing the connection between the terminal apparatus 101 and the communication apparatus 151 through the connection method using the wireless LAN includes the first setup and the second setup. Accordingly, in the present embodiment, it is assumed that the first setup and the second setup are included in the setups that can be executed when the region 1011 is selected. In other words, the region 1011 is an option corresponding to at least the second setup. Additionally, the network setup for establishing the connection between the terminal apparatus 101 and the communication apparatus 151 through the connection method using the wired LAN includes the third setup. Accordingly, in the present embodiment, it is assumed that the third setup is included in the setups that can be executed when the region 1012 is selected. In other words, the region 1011 is an option corresponding to at least the third setup. Additionally, the selection screen 1010 may include, for example, a region for selecting a connection method using USB, a region for selecting a connection method using Bluetooth, and the like. If the region for selecting the connection method using USB is selected, connection setup using USB is executed as the third setup. If the region for selecting the connection method using Bluetooth is selected, connection setup using Bluetooth is executed as the third setup.

If the user presses the button 1013 after selecting one of the connection methods by selecting the region 1011 or the region 1012, the CPU 103 moves the sequence to step S309.

In step S309, the CPU 103 determines whether the connection method using the wireless LAN has been selected in the selection screen 1010. The CPU 103 moves the sequence to step S310 if a determination of “yes” is made, and to step S313 if a determination of “no” is made.

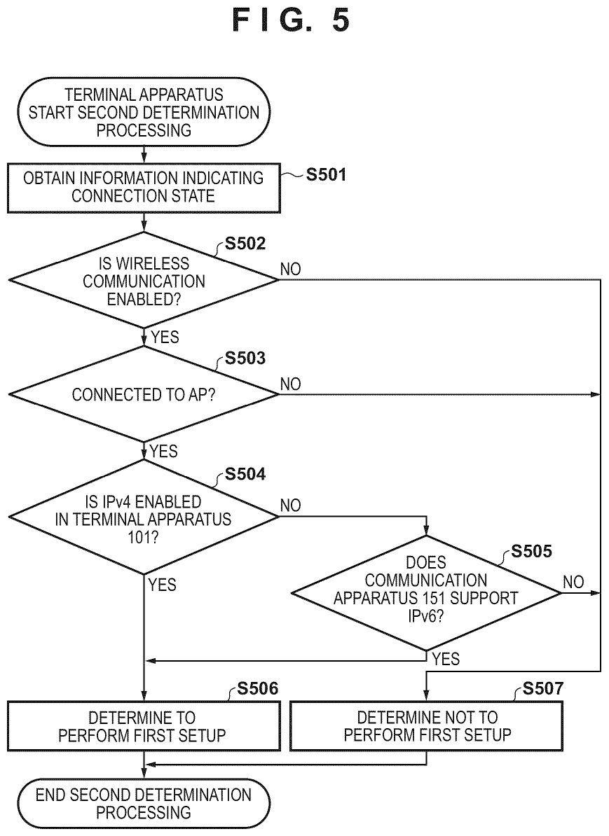

In step S310, the CPU 103 executes second determination processing for determining whether to perform the first setup. This second determination processing will be described later in detail with reference to FIG. 5.

In step S311, the CPU 103 determines, in the second determination processing, whether the first setup has been determined to be performed. The CPU 103 moves the sequence to step S307 if a determination of “yes” is made, and to step S312 if a determination of “no” is made.

In step S312, the CPU 103 displays a first guide screen for the second setup on the display unit 108. Here, a guide screen 1040 illustrated in FIG. 10D is displayed on the display unit 108 as the first guide screen, for example. For example, the guide screen 1040 includes a region 1042 for displaying a manual describing an operation method for the user to perform the second setup in a web browser of the terminal apparatus 101, and a button 1041 for displaying a next screen. If the region 1042 is selected, the CPU 103 launches the web browser of the terminal apparatus 101, and displays the manual in the web browser. Note that the configuration is not limited thereto, and the manual may be displayed directly in the setup application instead of in the web browser. The sequence moves to step S314 when the button 1041 is pressed by the user.

In step S313, the CPU 103 displays a second guide screen for the third setup on the display unit 108. Here, a guide screen 1050 illustrated in FIG. 10E is displayed on the display unit 108 as the second guide screen, for example. For example, the guide screen 1050 includes a region 1052 for displaying a manual describing an operation method for the user to perform the third setup in a web browser of the terminal apparatus 101, and a button 1051 for displaying a next screen. Furthermore, the method itself for the user to perform the third setup may be included in the guide screen 1050. Specifically, for example, the guide screen 1050 may include a region prompting the user to connect the AP and the communication apparatus 151 over a wired LAN (a LAN cable). Additionally, if the third setup is a connection setup using USB, the guide screen 1050 may be a screen for prompting the user to connect the terminal apparatus 101 and the communication apparatus 151 using a USB cable. If the third setup is a connection setup using Bluetooth, the guide screen 1050 may be a screen for prompting the user to connect the terminal apparatus 101 and the communication apparatus 151 using Bluetooth.

In step S314, the CPU 103 searches for the communication apparatus 151 on the network to which the terminal apparatus 101 belongs, which is a network formed by the AP. When one of the first setup, the second setup, and the third setup is executed, and the communication apparatus 151 and the terminal apparatus 101 are connected to the same AP, the communication apparatus 151 is discovered through this search.

In step S315, the CPU 103 determines whether the communication apparatus 151 has been discovered through the search performed in step S314. The CPU 103 moves the sequence to step S316 if a determination of “yes” is made, and to step S317 if a determination of “no” is made. Note that when this processing is executed after the first setup, the CPU 103 specifies whether the communication apparatus 151, to which the configuration information is to be transmitted as a result of the first setup, is included in the one or more apparatuses discovered through the search in step S314. If the communication apparatus 151 is identified as being included, a determination of “yes” is made in this determination. In other words, when not even a single apparatus is discovered through the search in step S314, or the communication apparatus 151 to which the configuration information is to be transmitted through the first setup is not included in the one or more apparatuses discovered, a determination of “no” is made in this determination. When this processing is executed after the second setup or the third setup, the CPU 103 displays the one or more apparatuses discovered through the search in step S314, and accepts a selection from the user. When a selection from the user has been accepted, a determination of “yes” is made in this determination. In other words, when not even a single apparatus is discovered through the search in step S314, and a selection from the user is not accepted, a determination of “no” is made in this determination.

In step S316, the CPU 103 displays a success screen, which is a screen corresponding a case where the communication apparatus 151 was discovered through the search performed in step S314, on the display unit 108. Here, for example, a success screen 1020 illustrated in FIG. 10B is displayed on the display unit 108. For example, the success screen 1020 includes a message indicating that the communication apparatus 151 has been discovered, a message indicating that the connection with the communication apparatus 151 has been successful, or the like. When an end button 1021 included in the success screen 1020 is pressed, the processing of this flowchart ends.

If the communication apparatus 151 has been discovered through the search performed in step S314, the CPU 103 may obtain capability information pertaining to the capabilities of the communication apparatus 151 from the communication apparatus 151. The capability information may then be used in print configuration processing for configuring a print job to be transmitted to the communication apparatus 151, scan configuration processing for configuring a scan job to be transmitted to the communication apparatus 151, and the like. The capability information is, for example, information indicating what type of sheets can be printed, information indicating whether scanning can be performed, or the like.

In step S317, the CPU 103 displays a failure screen, which is a screen corresponding to a case where the communication apparatus 151 was not discovered through the search performed in step S314, on the display unit 108. Here, for example, a failure screen 1030 illustrated in FIG. 10C is displayed on the display unit 108. For example, the failure screen 1030 includes a message indicating that the communication apparatus 151 could not be discovered, a message indicating that the connection with the communication apparatus 151 has failed, or the like. When an end button 1031 included in the failure screen 1030 is pressed, the processing of this flowchart ends.

FIG. 4 is a flowchart illustrating the first determination processing executed by the terminal apparatus 101. This flowchart is implemented by the CPU 103 reading out a program stored in the ROM 104 into the RAM 105 and executing the program. Note that the present embodiment assumes that the terminal apparatus 101 executes the processing using the setup app. This flowchart corresponds to the processing performed in step S303.

In step S401, the CPU 103 obtains information indicating a connection state of the wireless communication unit 109 from the OS of the terminal apparatus 101. In other words, the connection state of the wireless communication unit 109 is a state in which the terminal apparatus 101 is connected using Wi-Fi.

In step S402, the CPU 103 determines whether the terminal apparatus 101 is connected to any AP on the basis of the information obtained in step S401. The CPU 103 moves the sequence to step S403 if a determination of “yes” is made, and to step S410 if a determination of “no” is made.

In step S403, the CPU 103 specifies the SSID of the AP to which the terminal apparatus 101 is connected and the encryption method used by the AP to which the terminal apparatus 101 is connected.

In step S404, the CPU 103 obtains a list of wireless profiles held by the terminal apparatus 101 from the OS of the terminal apparatus 101. This processing corresponds to processing by which the setup app obtains a list of wireless profiles held by the terminal apparatus 101 from the OS of the terminal apparatus 101. The wireless profile held by the terminal apparatus 101 is information pertaining to APs to which the terminal apparatus 101 has previously connected, and is information managed and stored by the OS of the terminal apparatus 101. Specifically, the wireless profile held by the terminal apparatus 101 is the SSID of an AP to which the terminal apparatus 101 has previously connected, the password for connecting to the AP to which the terminal apparatus 101 has previously connected, and the like.

In step S405, the CPU 103 determines whether the wireless profile corresponding to the AP to which the terminal apparatus 101 is connected is included in the list obtained in step S404. The CPU 103 moves the sequence to step S407 if a determination of “yes” is made, and to step S406 if a determination of “no” is made. A case where a determination of “yes” is made corresponds to a case where the wireless profile corresponding to the AP to which the terminal apparatus 101 is connected is saved in the terminal apparatus 101 in advance before the predetermined instruction is accepted from the user by the setup app. As described above, depending on the type, version, and the like of the OS of the terminal apparatus 101, when the reconnection function is disabled, the OS will not save the wireless profile pertaining to an AP even if that AP is newly connected. Accordingly, a case where the wireless profile corresponding to the AP to which the terminal apparatus 101 is connected is not included in the list obtained in step S404 is a case where that wireless profile was not saved due to the setting being enabled.

In step S406, on the basis of the encryption method specified in step S403, the CPU 103 determines whether a password is required for connecting to the AP to which the terminal apparatus 101 is connected. A case where a password is required for connecting to the AP to which the terminal apparatus 101 is connected is a case where an encryption method such as Wired Equivalent Privacy (WEP), Wi-Fi Protected Access (WPA), WPA2, WPA3, or the like is specified in step S403 as the encryption method set for the AP to which the terminal apparatus 101 is connected. On the other hand, a case where a password is not required for connecting to the AP to which the terminal apparatus 101 is connected is a case where an encryption method is not set for the AP to which the terminal apparatus 101 is connected, and thus no encryption method is specified in step S403. This is also a case where the network formed by the AP to which the terminal apparatus 101 is connected is an open network. The CPU 103 moves the sequence to step S410 if a determination of value of “yes” is made, and to step S407 if a determination of “no” is made.

In step S407, the CPU 103 determines, on the basis of the information obtained in step S401, whether communication by the wireless communication unit 109 using IPv4 is enabled in the terminal apparatus 101. The CPU 103 moves the sequence to step S409 if a determination of step “yes” is made, and to step S408 if a determination of step “no” is made.

Note that in the present embodiment, communication between the terminal apparatus 101 and the communication apparatus 151 is performed by the wireless communication unit 109 before step S407, in the communication performed in step S401 and the like. Accordingly, if communication by the wireless communication unit 109 using IPv4 is not enabled in the terminal apparatus 101, it is assumed that communication by the wireless communication unit 109 using Internet Protocol version 6 (IPv6) is enabled in the terminal apparatus 101. Accordingly, in the present embodiment, it is assumed that the processing for determining whether communication by the wireless communication unit 109 using IPv6 is enabled is not executed in the terminal apparatus 101 after step S407. However, assuming a case were the setting is changed after the communication performed by the wireless communication unit 109 between the terminal apparatus 101 and the communication apparatus 151 before step S407, the processing for determining whether communication by the wireless communication unit 109 using IPv6 is enabled in the terminal apparatus 101 on the basis of the information obtained in step S401 may be executed after a determination of “no” is made in step S407. The CPU 103 then moves the sequence to step S408 if a determination of “yes” is made, and to step S410 if a determination of “no” is made.

In step S408, the CPU 103 determines whether the communication apparatus 151 specified as the target apparatus in step S302 supports P2P communication using IPv6. “Supporting P2P communication using IPv6” corresponds to having a function for P2P communication using IPv6. Specifically, in this determination, the CPU 103 determines whether the beacon transmitted from the communication apparatus 151 and detected in step S302 includes information indicating that P2P communication using IPv6 is supported. Note that the method of this determination is not limited to that described above, and may be a method that determines, for example, whether the model of the communication apparatus 151 specified from the beacon transmitted from the communication apparatus 151 is a model which supports P2P communication using IPv6. The CPU 103 moves the sequence to step S409 if a determination of “yes” is made, and to step S410 if a determination of “no” is made.

Note that the present embodiment assumes that the determination of step S408 is made on the assumption that a communication apparatus 151 which can also use IPv6 for P2P communication using the connection configuration mode is present as an apparatus supported by the setup app. Accordingly, the determination of step S408 may be omitted if, for example, a communication apparatus 151 which can also use IPv6 for P2P communication using the connection configuration mode is not present as an apparatus supported by the setup app. In this case, the CPU 103 moves the sequence to step S409 if a determination of “yes” is made in step S407, and to step S410 if a determination of “no” is made. In other words, a case where a communication apparatus 151 which can also use IPv6 for P2P communication using the connection configuration mode is not present as an apparatus supported by the setup app is a case where only a communication apparatus 151 which uses IPv4 for P2P communication using the connection configuration mode is present as an apparatus supported by the setup app. Note that the communication apparatus 151 which uses only IPv4 for P2P communication using the connection configuration mode may also use IPv6 for P2P communication in a mode different from the connection configuration mode.

In step S409, the CPU 103 determines that the first setup is to be performed without executing the predetermined processing. Note that the result of this determination is referenced in step S304. The processing of this flowchart ends after step S409.

In step S410, the CPU 103 determines that the first setup is not to be performed without executing the predetermined processing. The result of this determination is referenced in step S304. The processing of this flowchart ends after step S410.

FIG. 5 is a flowchart illustrating the second determination processing executed by the terminal apparatus 101. This flowchart is implemented by the CPU 103 reading out a program stored in the ROM 104 into the RAM 105 and executing the program. Note that the present embodiment assumes that the terminal apparatus 101 executes the processing using the setup app. This flowchart corresponds to the processing performed in step S310.

In step S501, the CPU 103 obtains information indicating the connection state of the wireless communication unit 109 and information indicating the connection state of the wired communication unit 112 from the OS of the terminal apparatus 101. In other words, the connection state of the wired communication unit 112 is a state in which the terminal apparatus 101 is connected over a wired LAN.

In step S502, the CPU 103 determines whether communication by the wireless communication unit 109 is enabled on the basis of the information indicating the connection state of the wireless communication unit 109 obtained in step S501. The CPU 103 moves the sequence to step S503 if a determination of “yes” is made, and to step S507 if a determination of “no” is made.

In step S503, the CPU 103 determines whether the terminal apparatus 101 is connected to any AP by the wireless communication unit 109 or the wired communication unit 112 on the basis of the items of information obtained in step S501. The CPU 103 moves the sequence to step S504 if a determination of “yes” is made, and to step S507 if a determination of “no” is made.

In step S504, the CPU 103 determines whether communication by the wireless communication unit 109 using IPv4 is enabled in the terminal apparatus 101 on the basis of the information indicating the connection state of the wireless communication unit 109 obtained in step S501. The CPU 103 moves the sequence to step S506 if a determination of “yes” is made, and to step S505 if a determination of “no” is made.

In step S505, the CPU 103 determines whether the communication apparatus 151 specified as the target apparatus in step S302 supports P2P communication using IPv6. This determination is the same as that made in step S408. The CPU 103 moves the sequence to step S506 if a determination of “yes” is made, and to step S507 if a determination of “no” is made.

In step S506, the CPU 103 determines that the first setup is to be performed. The result of this determination is referenced in step S311. The processing of this flowchart ends after step S506.

In step S507, the CPU 103 determines that the first setup is not to be performed. The result of this determination is referenced in step S311. The processing of this flowchart ends after step S507.

FIG. 7 is a flowchart illustrating the first setup executed by the terminal apparatus 101. This flowchart is implemented by the CPU 103 reading out a program stored in the ROM 104 into the RAM 105 and executing the program. Note that the present embodiment assumes that the terminal apparatus 101 executes the processing using the setup app. This flowchart corresponds to the processing performed in step S307.

In step S701, the CPU 103 searches for the communication apparatus 151 operating in the connection configuration mode. The CPU 103 then determines whether a communication apparatus 151 operating in the connection configuration mode has been discovered. The CPU 103 moves the sequence to step S702 if a determination of “yes” is made, and to step S701 if a determination of “no” is made. Note that if a communication apparatus 151 operating in the connection configuration mode has already been discovered in step S302, this processing may be skipped.

In step S702, if an AP to which the terminal apparatus 101 is connected by the wireless communication unit 109 is present, the CPU 103 terminates the connection between the terminal apparatus 101 and that AP. At this time, the CPU 103 stores the connection information for reconnecting to the disconnected AP in a memory such as the ROM 104. In other words, in step S702, the CPU 103 stores information indicating the authentication method of the AP to which the terminal apparatus 101 has previously connected in the ROM 104. Here, the connection information stored in the ROM 104 includes information indicating the authentication method used by the AP. The authentication method is information such as “WPA3-SAE”, for example. This will be described in detail later. Information indicating the authentication method of the AP is also stored in the wireless profile. By executing an Application Programming Interface (API) provided by the OS, the CPU 103 can obtain all the wireless profiles held by the terminal apparatus 101. Through this, the CPU 103 can obtain the connection information stored in the ROM 104 (information indicating the authentication method and the like), as well as information indicating the authentication methods of APs to which the terminal apparatus 101 is not currently connected but to which the terminal apparatus 101 has connected in the past.

Note that the AP with which the connection was terminated in step S702 is, in other words, the AP to which the terminal apparatus 101 was connected when a predetermined user operation for network setup was performed for the communication apparatus 151. Additionally, the AP with which the connection was terminated in step S702 can be said to be the AP to which the terminal apparatus 101 was connected until just before the wireless connection between the communication apparatus 151 and the terminal apparatus 101 was established in step S703.

In step S703, the CPU 103 establishes a wireless connection between the communication apparatus 151 operating in the connection configuration mode and the terminal apparatus 101. In other words, in step S703, a direct wireless connection is established between the terminal apparatus 101 and the communication apparatus.

In step S704, the CPU 103 obtains a list of APs discovered by a search performed by the communication apparatus 151 from the communication apparatus 151 by transmitting an information obtainment request to the communication apparatus 151. In other words, the list of APs discovered by a search performed by the communication apparatus 151 is a list of networks discovered by a search performed by the communication apparatus 151. In other words, the SSIDs or the like of the APs discovered by the communication apparatus 151 through the search is included in the list of APs. In addition to the SSIDs of the APs, the list of APs includes information indicating the authentication methods used by the APs discovered by the communication apparatus 151 through the search.

In step S705, the CPU 103 determines whether the SSID of the AP corresponding to the connection information stored in step S702 is included in the list obtained in step S704. The CPU 103 moves the sequence to step S709 if a determination of “yes” is made, and to step S706 if a determination of “no” is made. If a determination of “yes” is made, the CPU 103 specifies the AP corresponding to the connection information stored in step S702 as the AP to which the communication apparatus 151 is to be connected.

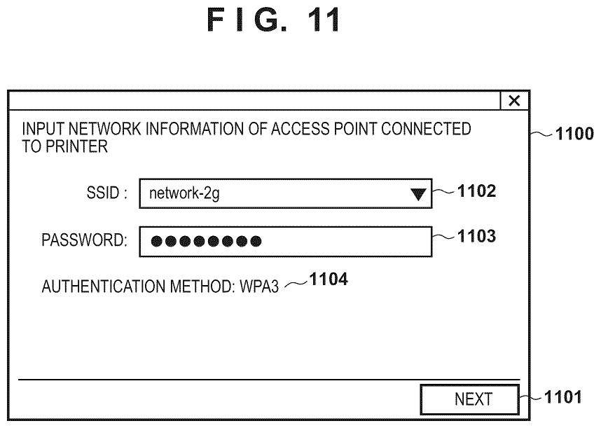

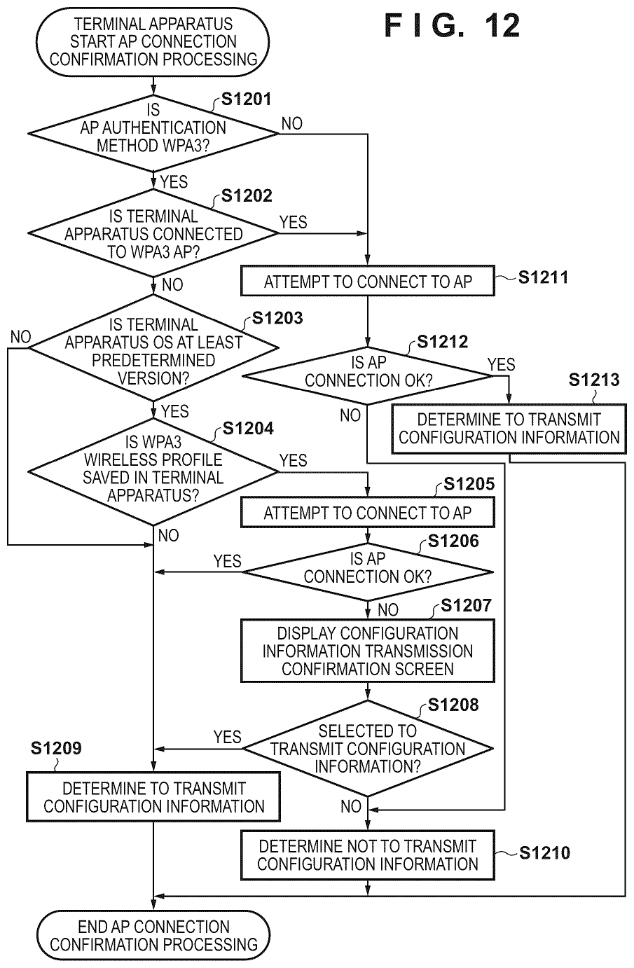

In step S706, the CPU 103 displays the list obtained in step S704 on the display unit 108, and accepts, from the user, the selection of one of the APs from the list. The selection of the AP is, in other words, a selection of the network formed by the AP. The CPU 103 specifies the AP selected by the user in step S706 as the AP to which the communication apparatus 151 is to be connected. Additionally, the CPU 103 obtains the connection information such as the password or the like for connecting to the AP selected by the user. In this processing, a screen such as that illustrated in FIG. 11 is displayed on the display unit 108 as an input screen 1100 for accepting the selection of an AP from the user, for example. The input screen 1100 includes a region 1102 for accepting the selection of an AP from the user, and a region 1103 for accepting the input of a password for connecting to the selected AP from the user. The CPU 103 obtains the password of the AP selected by the user through the region 1103, which is an interface capable of accepting the input of the password from the user. The input screen 1100 also includes a region 1104 indicating the authentication method used by the AP selected by the user, and a button 1101 for specifying the AP corresponding to the input information as the AP to which the communication apparatus 151 is to be connected. It is assumed that when the region 1102 is selected, the list obtained in step S704 is displayed in drop-down format. The region 1102 also functions as a text box in which any desired character string can be input.

Note that if the OS of the terminal apparatus 101 already holds the password used to connect to the AP selected by the user as the wireless profile, the CPU 103 may skip accepting the input of the password from the user. Additionally, if an authentication method is not set for the AP selected by the user, and a password is not required to connect to the AP, the input of the password need not be accepted from the user. The configuration is not limited to one in which the CPU 103 accepts a user selection of the AP from the list obtained in step S704 and specifies the AP for which the user selection was accepted as the AP to which the communication apparatus 151 is to be connected. For example, the configuration may be such that the CPU 103 accepts the input of any SSID or password from the user, and specifies the AP corresponding to the input information as the AP to which the communication apparatus 151 is to be connected. When the button 1101 is selected, the CPU 103 saves the selection made or the information input in the region 1102 of the input screen 1100, and the information input in the region 1103, as the configuration information to be transmitted. Note that at this time, the CPU 103 may perform processing for verifying whether the selection made or the information input in the input screen 1100 is correct. Specifically, the CPU 103 may verify whether the input password conforms to the format of the authentication method used by the selected AP.

In step S707, the CPU 103 executes AP connection confirmation processing. This processing will be described later in detail with reference to FIG. 12.

In step S708, the CPU 103 determines whether a determination to transmit the configuration information to the communication apparatus 151 has been made in step S707. The CPU 103 moves the sequence to step S709 if a determination of “yes” is made, and to step S706 if a determination of “no” is made.

In step S709, the CPU 103 transmits the configuration information pertaining to the AP specified as the AP to which the communication apparatus 151 is to be connected, to the communication apparatus 151. The configuration information includes connection information (the SSID, the password, or the like) for connecting to the AP specified as the AP to which the communication apparatus 151 is to be connected.

In step S710, the CPU 103 terminates the wireless connection between the communication apparatus 151 operating in the connection configuration mode and the terminal apparatus 101. Then, using the connection information stored in step S702, the CPU 103 establishes a connection between the AP corresponding to the connection information stored in step S702 and the terminal apparatus 101. At this time, the CPU 103 may establish a connection between the AP corresponding to the connection information transmitted in step S709 and the terminal apparatus 101 using the connection information transmitted in step S709.

In step S711, if the connection information for connecting to the communication apparatus 151 operating in the connection configuration mode is saved as a wireless profile by the OS, the CPU 103 deletes the wireless profile. This suppresses situations where the wireless connection between the communication apparatus 151 operating in the connection configuration mode and the terminal apparatus 101 is re-established at a timing not intended by the user. The processing of this flowchart then ends.

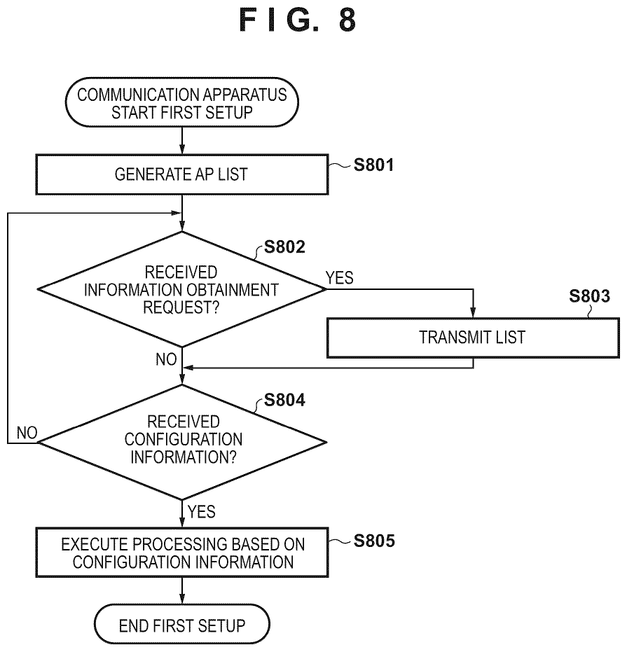

FIG. 8 is a flowchart illustrating the first setup executed by the communication apparatus 151. This flowchart is implemented by the CPU 154 reading out a program stored in the ROM 152 into the RAM 153 and executing the program. This flowchart is started on the basis of the communication apparatus 151 accepting a user operation for operating in the connection configuration mode. In other words, the communication apparatus 151 starts operating in connection configuration mode on the basis of the trigger described above.

In step S801, the CPU 154 searches for APs present around the communication apparatus 151 and generates a list of discovered APs.

In step S802, the CPU 154 determines whether an information obtainment request has been received from the terminal apparatus 101. The CPU 154 moves the sequence to step S803 if a determination of “yes” is made, and to step S804 if a determination of “no” is made.

Note that instead of executing step S801 before step S802, step S801 may be executed after a determination of “yes” is made in step S802.

In step S803, the CPU 154 transmits the list generated in step S801 to the terminal apparatus 101.

In step S804, the CPU 154 determines whether configuration information has been received from the terminal apparatus 101. The CPU 154 moves the sequence to step S805 if a determination of “yes” is made, and returns the sequence to step S802 if a determination of “no” is made.

In step S805, the CPU 154 performs network setup on the basis of the received configuration information. Specifically, using the connection information included in the received configuration information, the CPU 154 establishes a connection between the AP corresponding to the connection information included in the received configuration information and the communication apparatus 151. The processing of this flowchart then ends.

FIG. 12 is a flowchart illustrating the AP connection confirmation processing executed by the terminal apparatus 101 according to the present embodiment. This flowchart is implemented by the CPU 103 reading out a program stored in the ROM 104 into the RAM 105 and executing the program. Note that the present embodiment assumes that the terminal apparatus 101 executes the processing using the setup app. This flowchart corresponds to the processing performed in step S707.

In step S1201, the CPU 103 determines whether the authentication method used by the AP selected in step S706 is the predetermined authentication method. The CPU 103 moves the sequence to step S1202 if a determination of “yes” is made, and to step S1211 if a determination of “no” is made. Specifically, in step S1201, the CPU 103 makes this determination on the basis of information indicating the authentication method of the AP selected in step S706. Additionally, as described above, the information indicating the authentication method of the AP selected in step S706 is information included in the list of APs obtained in step S704. Note that in the following descriptions, the AP selected in step S706 may be called a “user-selected AP”.

More specifically, in step S1201, the CPU 103 makes a determination of “yes” if, for example, the information indicating the authentication method of the user-selected AP is “WPA3-SAE”, “WPA2-WPA3 Mix-PSK”, “WPA3-EAP”, or the like, and makes a determination of “no” if not. “WPA3-SAE” indicates an AP that supports WPA3 and uses the Simultaneous Authentication of Equals (SAE) method for the authentication method. “WPA2-WPA3 Mix-PSK” indicates an AP that supports both WPA3 and WPA2 and uses the PSK (Pre-Shared Key) method for the authentication method. “WPA3-EAP” indicates an AP that supports WPA3 and uses the Extensible Authentication Protocol (EAP) for the authentication method. In other words, the information indicating the authentication method can also be said to be information indicating the security method of the AP.

In step S1202, the CPU 103 determines whether the terminal apparatus 101 has previously connected to an AP that uses the predetermined authentication method. The CPU 103 moves the sequence to step S1211 if a determination of “yes” is made, and to step S1203 if a determination of “no” is made. Specifically, the CPU 103 determines whether the terminal apparatus 101 has previously connected to an AP that uses one of the WPA3-SAE, WPA2-WPA3 Mix-PSK, and WPA3-EAP authentication methods.

The determination made in step S1202 will be described in further detail. Specifically, in step S1202, the CPU 103 determines whether the AP for which the connection was terminated in step S702 is an AP using the predetermined authentication method. As described above, the CPU 103 stores the connection information of the AP for which the connection was terminated in step S702 is a memory such as the ROM 104. Additionally, information indicating the authentication method of the AP is included in the connection information stored in the memory such as the ROM 104. Accordingly, in step S1202, the CPU 103 obtains information indicating the authentication method of the AP included in the connection information stored in the memory such as the ROM 103, and determines whether the AP for which the connection was terminated in step S702 is an AP that uses the predetermined authentication method.

Note that in step S1202, the CPU 103 may determine whether the terminal apparatus 101 has previously connected to an AP using the predetermined authentication method using an OS API of the terminal apparatus 101, for example. As described above, information indicating the authentication method of the AP is also stored in the wireless profile. Accordingly, in step S1202, the CPU 103 executes the API of the OS of the terminal apparatus 101, and obtains all the wireless profiles held by the terminal apparatus 101. The CPU 103 may then determine whether the obtained wireless profile includes information indicating the authentication method described above.

In this manner, in the present embodiment, when the user-selected AP uses the predetermined authentication method (“yes” in step S1201), the CPU 103 determines whether the terminal apparatus 101 has previously connected to an AP that uses the predetermined authentication method. If the terminal apparatus 101 has previously connected to an AP that uses the predetermined authentication method, the terminal apparatus 101 can be assumed to support the predetermined authentication method. Accordingly, when a determination of “yes” has been made in step S1202, the CPU 103 moves the sequence to step S1211 and attempts to connect to the AP. Such a configuration makes it possible to prevent situations where the terminal apparatus 101 fails to connect to the user-selected AP due the user-selected AP not being supported. On the other hand, if the terminal apparatus 101 has not previously connected to an AP that uses the predetermined authentication method, it is not known whether the terminal apparatus 101 supports the predetermined authentication method. Accordingly, when a determination of “no” is made in step S1202, the CPU 103 moves the sequence to step S1203 and makes a further determination. In other words, the determination in step S1202 is confirmation processing for confirming whether the terminal apparatus 101 supports a predetermined AP.

In step S1203, the CPU 103 determines whether the OS of the terminal apparatus 101 is at least a predetermined version. The CPU 103 moves the sequence to step S1204 if a determination of “yes” is made, and to step S1209 if a determination of “no” is made. Note that the OS being at least a predetermined version means that the OS of the terminal apparatus 101 can store information indicating the predetermined authentication method in the wireless profile. The predetermined version is a version that can support the predetermined authentication method, and specifically is Windows 10 1909, for example. In other words, the OS being at least a predetermined version corresponds to, for example, the OS being “Windows” and the version being at least “Windows 10 1909”. In other words, it can also be said that in step S1203, the CPU 103 determines whether there is the possibility that the terminal apparatus 101 supports the predetermined authentication method on the basis of the version of the OS of the terminal apparatus 101. If the version of the OS of the terminal apparatus 101 is a version earlier than the predetermined version, the terminal apparatus 101 can be assumed not to support the predetermined authentication method. Accordingly, when a determination of “no” is made in step S1203, the CPU 103 moves the sequence to step S1209 without attempting to connect to the AP.

In step S1204, the CPU 103 determines whether the terminal apparatus 101 does not include a plurality of wireless communication units 109 and whether the information indicating the predetermined authentication method is included in the wireless profile. If a determination of “yes” is made, the CPU 103 moves the sequence to step S1205. If the OS of the terminal apparatus 101 holds a wireless profile that includes information indicating the predetermined authentication method, it is possible that the wireless communication unit 109 supports the predetermined authentication method. Accordingly, when the terminal apparatus 101 makes a determination of “yes”, the CPU 103 moves the sequence to step S1205 and attempts to connect to the AP. On the other hand, if a determination of “no” is made, the CPU 103 moves the sequence to step S1209. The wireless profile does not hold information indicating which wireless communication unit of the terminal apparatus 101 saved the wireless profile. However, if there is only one wireless communication unit (the wireless communication unit 109 only) in the terminal apparatus 101, the wireless profile held by the terminal apparatus 101 can be considered to have been saved by the wireless communication unit 109. In other words, the CPU 103 can determine that there is a possibility that the wireless communication unit 109 supports all the authentication methods in the wireless profiles held by the terminal apparatus 101.

In this manner, in the present embodiment, the CPU 103 determines whether there is a possibility that the terminal apparatus 101 supports the predetermined authentication method in steps S1203 and S1204. Note that the configuration may be such that the CPU 103 skips the processing of steps S1203 and S1204 in the AP connection confirmation processing. In other words, when a determination of “no” is made in step S1202, the CPU 103 may move the sequence to step S1209 without executing the processing of steps S1203 and S1204.

In step S1205, the CPU 103 terminates the wireless connection between the communication apparatus 151 and the terminal apparatus 101. Then, on the basis of the connection information such as the password obtained in step S706, the CPU 103 attempts to make a connection between the terminal apparatus 101 and the user-selected AP. If the connection between the terminal apparatus 101 and the user-selected AP is successful, the CPU 103 terminates the connection. The CPU 103 then establishes a wireless connection between the communication apparatus 151 and the terminal apparatus 101.

In step S1206, the CPU 103 determines whether the attempt to make a connection between the terminal apparatus 101 and the user-selected AP in step S1205 has resulted in a successful connection. The CPU 103 moves the sequence to step S1209 if a determination of “yes” is made, and to step S1207 if a determination of “no” is made.

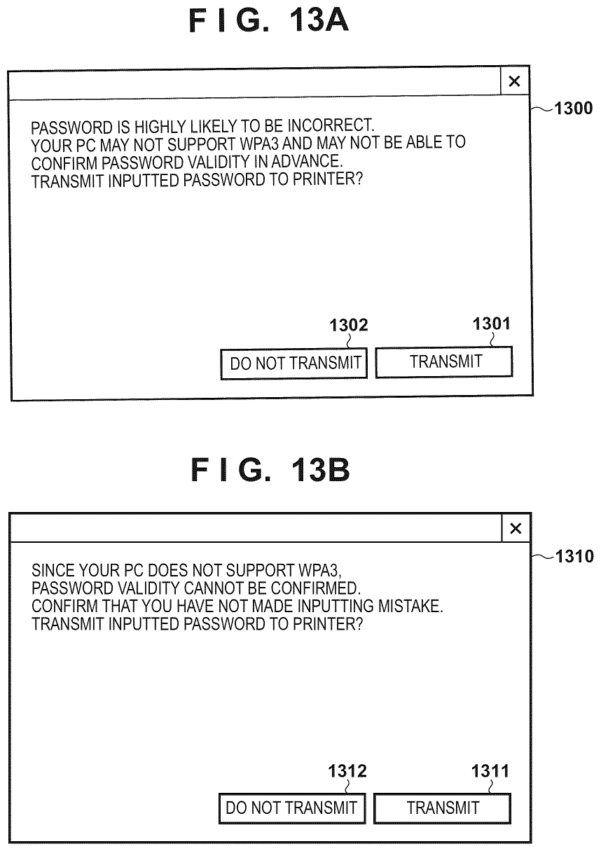

In step S1207, the CPU 103 displays, on the display unit 108, a confirmation screen for confirming whether to transmit the configuration information illustrated in FIG. 13A to the communication apparatus 151. FIG. 13A illustrates an example of a confirmation screen 1300 displayed on the display unit 108 in step S1207.

The screen 1300 displays a button 1301 capable of accepting a user instruction to transmit the configuration information from the terminal apparatus 101 to the communication apparatus 151. The screen 1300 also displays a button 1302 capable of accepting a user instruction to not transmit the configuration information from the terminal apparatus 101 to the communication apparatus 151. The screen 1300 further displays a message asking the user whether to transmit the password entered in the region 1103 in step S706 to the communication apparatus 151. In other words, the screen 1300 can also be said to be an interface (acceptance screen) capable of accepting a user selection as to whether to transmit the configuration information from the terminal apparatus 101 to the communication apparatus 151 when the connection to the user-selected AP fails. When the user presses either the button 1301 or the button 1302, the CPU 103 moves the sequence to step S1208.

Here, in step S1205, the connection between the terminal apparatus 101 and the user-selected AP has failed. The cause of the connection failure is assumed to be at least one of (i) the password entered by the user being incorrect and (ii) the terminal apparatus 101 not supporting the predetermined authentication method. Accordingly, the screen 1300 displays a message indicating that the password entered in the region 1103 by the user in step S706 may be incorrect, and a message indicating that the terminal apparatus 101 may not support the predetermined authentication method. The screen 1300 further displays a message indicating that whether the password entered in the region 1103 by the user has not yet been confirmed to be correct. In other words, the screen 1300 notifies the user that the password entered by the user may be incorrect. Displaying these messages on the screen 1300 enables the user to recognize that the password they entered may be incorrect before transmitting the configuration information from the terminal apparatus 101 to the communication apparatus 151.

Note that a message indicating that the connection between the terminal apparatus 101 and the user-selected AP has failed may be displayed on the screen 1300.

In step S1208, the CPU 103 determines whether the button 1301 was pressed in step S1207. The CPU 103 moves the sequence to step S1209 if a determination of “yes” is made, and to step S1210 if a determination of “no” is made.

In step S1209, the CPU 103 determines that the configuration information is to be transmitted from the terminal apparatus 101 to the communication apparatus 151. Note that the result of this determination is referenced in step S708. In other words, the CPU 103 controls the connection information of the user-selected AP to be transmitted from the terminal apparatus 101 to the communication apparatus 151. The processing of this flowchart ends after step S1209.

In step S1210, the CPU 103 determines that the configuration information is not to be transmitted from the terminal apparatus 101 to the communication apparatus 151. The result of this determination is referenced in step S708. In other words, the CPU 103 controls the connection information of the user-selected AP to not be transmitted from the terminal apparatus 101 to the communication apparatus 151. The processing of this flowchart ends after step S1210.

In step S1211, the CPU 103 terminates the wireless connection between the communication apparatus 151 and the terminal apparatus 101. Then, on the basis of the connection information such as the password obtained in step S706, the CPU 103 attempts to make a connection between the terminal apparatus 101 and the user-selected AP. If the connection between the terminal apparatus 101 and the user-selected AP is established, the CPU 103 terminates the connection. The CPU 103 then establishes a wireless connection between the communication apparatus 151 and the terminal apparatus 101.

In step S1212, the CPU 103 determines whether the attempt to make a connection between the terminal apparatus 101 and the user-selected AP in step S1211 has resulted in a successful connection. The CPU 103 moves the sequence to step S1213 if a determination of “yes” is made, and to step S1210 if a determination of “no” is made.

In step S1213, the CPU 103 determines that the configuration information is to be transmitted from the terminal apparatus 101 to the communication apparatus 151. Note that the result of this determination is referenced in step S708. In other words, the CPU 103 controls the connection information of the user-selected AP to be transmitted from the terminal apparatus 101 to the communication apparatus 151. The processing of this flowchart ends after step S1213.

According to the present embodiment as described thus far, the terminal apparatus 101 operates as follows using the setup app. The terminal apparatus 101 obtains the connection information, such as a password or the like, for connecting to the user-selected AP. When the authentication method of the user-selected AP is a predetermined authentication method such as WPA3-SAE, the terminal apparatus 101 determines whether the terminal apparatus 101 has previously connected to an AP that uses the predetermined authentication method. If the terminal apparatus 101 is determined to have previously connected to an AP that uses the predetermined authentication method, the terminal apparatus 101 can be assumed to support that authentication method. Accordingly, if the terminal apparatus 101 is determined to have previously connected to an AP that uses the predetermined authentication method, an attempt is made to make a connection between the terminal apparatus 101 and the AP selected by the user on the basis of the connection information. Attempting to connect to the AP when the terminal apparatus 101 supports the predetermined authentication method in this manner makes it possible to prevent the connection to the AP from failing due to the terminal apparatus 101 not supporting the authentication method of the AP. This also makes it possible to prevent situations where configuration information including erroneous connection information is transmitted to the communication apparatus 151 without attempting to connect to the AP regardless of whether the terminal apparatus 101 supports the authentication method of the AP. In other words, the terminal apparatus 101 can appropriately perform processing pertaining to the connection information for an AP.

In the present embodiment, the terminal apparatus 101 further makes the following determination even if the terminal apparatus 101 is determined not to have previously connected to an AP that uses the predetermined authentication method. Specifically, the terminal apparatus 101 determines whether there is the possibility that the terminal apparatus 101 supports the predetermined authentication method using the version of the OS of the terminal apparatus 101, the wireless profile, or the like. The terminal apparatus 101 can then attempt to connect to the user-selected AP when it is determined that there is a possibility that the predetermined authentication method is supported.

In the present embodiment, when the terminal apparatus 101 determines that there is a possibility that the predetermined authentication method is supported and the connection fails as a result of attempting to connect to the user-selected AP, the following notification is made. Specifically, the terminal apparatus 101 notifies the user that the password or the like entered by the user may be incorrect. Such a notification enables the user to recognize that the password or the like may be incorrect before transmitting the connection information from the terminal apparatus 101 to the communication apparatus 151.

### Second Embodiment

In the first embodiment, the terminal apparatus 101 has an OS that manages wireless profiles, and each wireless profile includes information indicating an authentication method. The setup app can obtain a wireless profile including information indicating an authentication method from the OS of the terminal apparatus 101. As a result, the CPU 103 determines whether there is a possibility that the terminal apparatus 101 supports the predetermined authentication method using the wireless profile in step S1204, for example. On the other hand, there are situations where the setup app cannot obtain a wireless profile including information indicating an authentication method from the OS. Specifically, for example, if the OS of the terminal apparatus 101 is macOS (registered trademark), the setup app cannot obtain a wireless profile including information indicating an authentication method from the OS of the terminal apparatus 101. The present embodiment will describe AP connection confirmation processing used in such a situation. Note that the present embodiment is not limited to a configuration in which the setup app cannot obtain a wireless profile including information indicating an authentication method from the OS of the terminal apparatus 101. For example, the processing of the present embodiment may be executed even in a configuration in which the OS of the terminal apparatus 101 is Windows and the setup app can obtain a wireless profile including information indicating an authentication method from the OS of the terminal apparatus 101. When the processing according to the present embodiment is executed in a configuration where the OS of the terminal apparatus 101 is Windows, there is an advantage in that the processing can be completed more quickly than when the processing according to the first embodiment is executed.

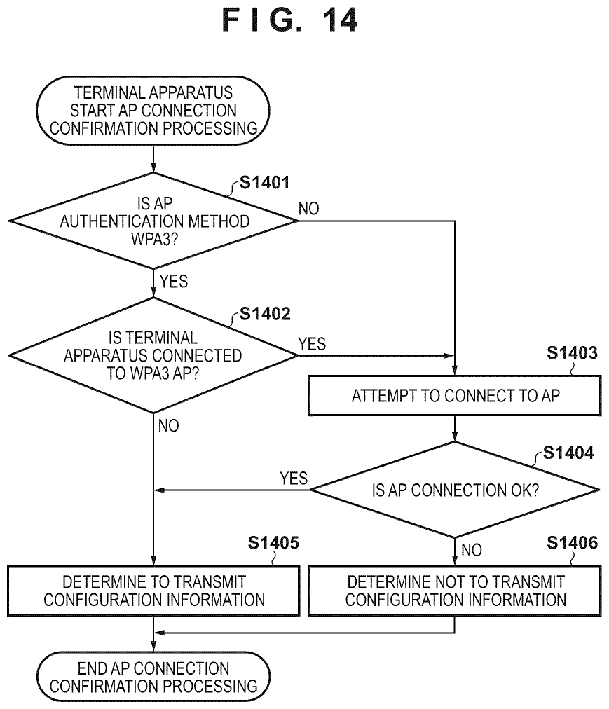

FIG. 14 is a flowchart illustrating the AP connection confirmation processing executed by the terminal apparatus 101 according to the present embodiment. This flowchart is implemented by the CPU 103 reading out a program stored in the ROM 104 into the RAM 105 and executing the program. Note that the present embodiment assumes that the terminal apparatus 101 executes the processing using the setup app. This flowchart corresponds to the processing performed in step S707. Additionally, the present embodiment assumes that in step S702 performed before executing this flowchart, the CPU 103 obtains the connection information by executing an API of the OS when storing the connection information for connecting to the AP in a memory such as the ROM 104. It is also assumed that even if the API of the OS is executed, the connection information pertaining to the AP to which the terminal apparatus 101 was connected before the start of the processing of step S702 is not obtained.

Step S1401 is similar to step S1201 of FIG. 12, and will therefore not be described.

In step S1402, the CPU 103 determines whether the authentication method used by the AP corresponding to the connection information stored in step S702 is the predetermined authentication method. Note that the determination in step S1402 is made in the same manner as in step S1202, and will therefore not be described in detail. The CPU 103 moves the sequence to step S1403 if a determination of “yes” is made, and to step S1405 if a determination of “no” is made.

In the first embodiment, when a determination of “no” was made in step S1202, the CPU 103 moved the sequence to step S1203, whereupon whether the version of the OS of the terminal apparatus 101 is at least a predetermined version was determined. When a determination of “yes” was made in step S1203, the sequence moved to step S1204, where the CPU 103 determined whether information indicating the predetermined authentication method was included in the wireless profile. However, in the present embodiment, as described above, although the terminal apparatus 101 has an OS that manages wireless profiles, each wireless profile does not include information indicating an authentication method. A determination such as that made in step S1204 cannot be executed in such a terminal apparatus 101. Accordingly, in the present embodiment, when a determination of “no” is made in step S1402, the sequence moves to step S1405. This makes it possible to skip processing that uses the wireless profile when the wireless profile does not include information indicating the authentication method.

Note that steps S1403 and S1404 are similar to steps S1211 and S1212, and steps S1405 and S1406 are similar to steps S1209 and S1209, and these steps will therefore not be described here.

According to the present embodiment as described thus far, the setup app causes the terminal apparatus 101 to operate as follows. If the terminal apparatus 101 is determined not to have previously connected to an AP that uses the predetermined authentication method (“no” in step S1402), the terminal apparatus 101 performs control for transmitting the configuration information of the AP to the communication apparatus 151. This makes it possible to skip processing that uses the wireless profile when the wireless profile does not include information indicating the authentication method. However, if the terminal apparatus 101 is determined to have previously connected to an AP that uses the predetermined authentication method (“yes” in step S1402), the terminal apparatus 101 attempts to connect to the AP in the same manner as in the first embodiment. Such a configuration makes it possible to appropriately control whether the terminal apparatus 101 transmits the connection information, even if the OS of the terminal apparatus 101 is an OS that manages wireless profiles which do not include information indicating an authentication method.

### Third Embodiment

In the first and second embodiments, when the authentication method used by the user-selected AP was a predetermined authentication method, the CPU 103 determined whether the terminal apparatus 101 supports the predetermined authentication method. Then, when the terminal apparatus 101 was determined to support the predetermined authentication method, the CPU 103 attempted to make a connection between the terminal apparatus 101 and the AP. In the present embodiment, in the AP connection confirmation processing, the CPU 103 first attempts to make a connection between the terminal apparatus 101 and the user-selected AP. Then, if the connection between the terminal apparatus 101 and the AP fails, the CPU 103 determines whether the terminal apparatus 101 has previously connected to an AP that uses the predetermined authentication method. Note that the present embodiment assumes that the terminal apparatus 101 has an OS that can refer to the wireless profile from the setup app. Note also that the OS according to the present embodiment is Windows (registered trademark), for example.

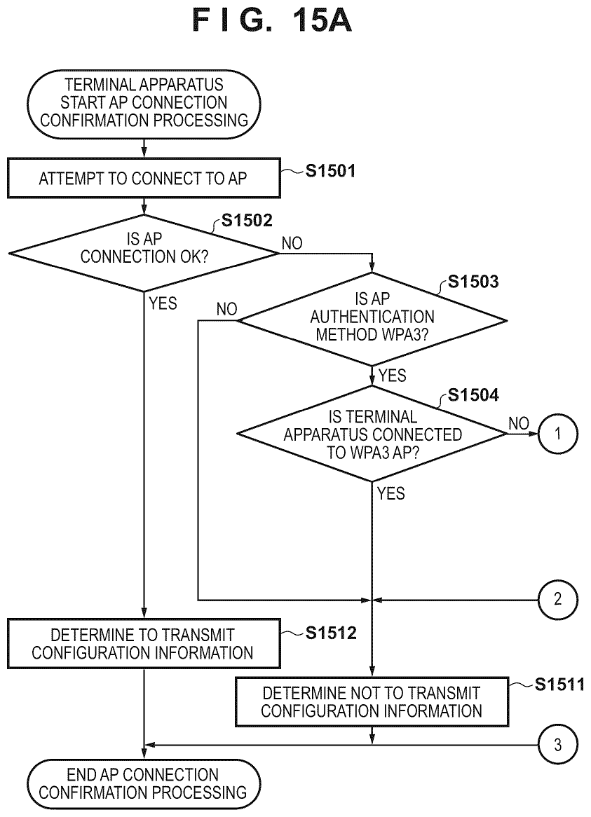

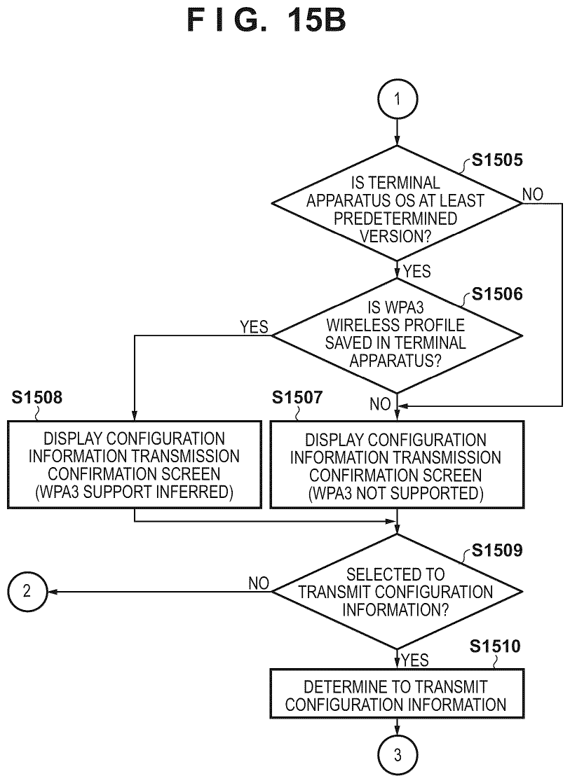

FIGS. 15A and 15b are flowcharts illustrating the AP connection confirmation processing executed by the terminal apparatus 101 according to the present embodiment. This flowchart is implemented by the CPU 103 reading out a program stored in the ROM 104 into the RAM 105 and executing the program. Note that the present embodiment assumes that the terminal apparatus 101 executes the processing using the setup app. This flowchart corresponds to the processing performed in step S707.

In step S1501, the CPU 103 terminates the wireless connection between the communication apparatus 151 and the terminal apparatus 101. Then, on the basis of the connection information of the user-selected AP obtained in step S706, the CPU 103 attempts to make a connection between the terminal apparatus 101 and the user-selected AP. If the connection between the terminal apparatus 101 and the user-selected AP is established, the CPU 103 terminates the connection. The CPU 103 then establishes a wireless connection between the communication apparatus 151 and the terminal apparatus 101.

In step S1502, the CPU 103 determines whether the attempt to make a connection between the terminal apparatus 101 and the user-selected AP in step S1501 has resulted in a successful connection. The CPU 103 moves the sequence to step S1512 if a determination of “yes” is made, and to step S1503 if a determination of “no” is made.

In step S1503, the CPU 103 determines whether the authentication method used by the user-selected AP is the predetermined authentication method. The CPU 103 moves the sequence to step S1504 if a determination of “yes” is made, and to step S1511 if a determination of “no” is made. Note that the determination in step S1503 is made in the same manner as in step S1201, and will therefore not be described in detail.

In step S1504, the CPU 103 determines whether the terminal apparatus 101 has previously connected to an AP that uses the predetermined authentication method. The CPU 103 moves the sequence to step S1511 if a determination of “yes” is made, and to step S1505 if a determination of “no” is made. Note that the determination in step S1504 is made in the same manner as in step S1202, and will therefore not be described in detail.

In this manner, in the present embodiment, in the AP connection confirmation processing, the CPU 103 first attempts to make a connection between the terminal apparatus 101 and the user-selected AP in step S1501. If the connection to the user-selected AP fails, the cause of the failure is assumed to be at least one of (i) the password entered by the user being incorrect and (ii) the terminal apparatus 101 not supporting the authentication method used by the user-selected AP. Accordingly, in the present embodiment, when the connection to the user-selected AP fails, whether the terminal apparatus 101 has previously connected to an AP that uses the predetermined authentication method is determined in step S1504. For example, if the terminal apparatus 101 has previously connected to an AP that uses the predetermined authentication method, the terminal apparatus 101 can be assumed to support the predetermined authentication method. Accordingly, the reason why the connection to the user-selected AP failed may be that the password entered by the user is incorrect. The CPU 103 therefore moves the sequence to step S1511 when a determination of “yes” is made in step S1504. On the other hand, if, for example, the terminal apparatus 101 has not previously connected to an AP that uses the predetermined authentication method, it is not known whether the terminal apparatus 101 supports the predetermined authentication method. The CPU 103 therefore moves the sequence to step S1505 when a determination of “no” is made in step S1504.

In step S1505, the CPU 103 determines whether the OS of the terminal apparatus 101 is at least a predetermined version. The CPU 103 moves the sequence to step S1506 if a determination of “yes” is made, and to step S1507 if a determination of “no” is made. Note that the determination in step S1505 is made in the same manner as in step S1203, and will therefore not be described in detail.

In step S1506, the CPU 103 determines whether the terminal apparatus 101 does not include a plurality of wireless communication units 109 and whether the information indicating the predetermined authentication method is included in the wireless profile. The CPU 103 moves the sequence to step S1508 if a determination of “yes” is made, and to step S1507 if a determination of “no” is made. Note that the determination in step S1506 is made in the same manner as in step S1204, and will therefore not be described in detail.

In step S1507, the CPU 103 displays a configuration information transmission confirmation screen, illustrated in FIG. 13B, on the display unit 108. FIG. 13B illustrates an example of a confirmation screen 1310 displayed on the display unit 108 in step S1207.

The screen 1310 displays a button 1311 capable of accepting a user instruction to transmit the configuration information from the terminal apparatus 101 to the communication apparatus 151. The screen 1310 also displays a button 1312 capable of accepting a user instruction to not transmit the configuration information from the terminal apparatus 101 to the communication apparatus 151. The screen 1300 displays a message asking the user whether to transmit the password entered in the region 1103 in step S706 to the communication apparatus 151. In other words, the screen 1310 is an interface capable of accepting a user selection as to whether to transmit the configuration information from the terminal apparatus 101 to the communication apparatus 151. When the user presses either the button 1311 or the button 1312, the CPU 103 moves the sequence to step S1509.

Here, in step S1501, the connection between the terminal apparatus 101 and the user-selected AP has failed. In addition, the terminal apparatus 101 is determined not to have previously connected to an AP that uses the predetermined authentication method in step S1504. Furthermore, it can be determined that there is no possibility that the terminal apparatus 101 supports the predetermined authentication method through the processing of steps S1505 to S1508. Accordingly, because the terminal apparatus 101 does not support the predetermined authentication method, a message indicating that the password, which is the connection information, could not be confirmed to be correct is displayed on the screen 1310. Such a message makes it possible to make a notification indicating that whether the password entered by the user in step S706 is correct has not been confirmed because the terminal apparatus 101 does not support the predetermined authentication method. Displaying these messages on the screen 1310 enables the user to recognize that the password they entered may be incorrect before transmitting the configuration information from the terminal apparatus 101 to the communication apparatus 151.

In step S1508, the CPU 103 displays, on the display unit 108, a confirmation screen for confirming whether to transmit the configuration information illustrated in FIG. 13A to the communication apparatus. Here, it is determined that there is a possibility that the terminal apparatus 101 supports the predetermined authentication method through the processing of steps S1505 to S1506. Accordingly, the CPU 103 displays the confirmation screen 1300 described above, and makes a notification indicating that the password entered by the user may be incorrect.

In this manner, in the present embodiment, when it is determined, through the processing of steps S1505 and S1506, that there is no possibility that the terminal apparatus 101 supports the predetermined authentication method (“no” in step S1505 and “no” in step S1506), the CPU 103 displays the confirmation screen 1310. If it is determined, through the processing of steps S1505 and S1506, that there is a possibility that the terminal apparatus 101 supports the predetermined authentication method (“yes” in step S1505 and “yes” in step S1506), the CPU 103 displays the confirmation screen 1300. In other words, the CPU 103 controls the display of the confirmation screen on the basis of a determination as to whether there is a possibility that the terminal apparatus 101 supports the predetermined authentication method. Accordingly, even if the terminal apparatus 101 fails to connect to the AP, the user can be notified of the appropriate content.

In step S1509, the CPU 103 determines whether a button for transmitting the configuration information from the terminal apparatus 101 to the communication apparatus 151 has been selected. When either the button 1301 or the button 1311 is pressed, the CPU 103 moves the sequence to step S1510. On the other hand, when either the button 1302 or the button 1312 is pressed, the CPU 103 moves the sequence to step S1511.

In step S1510, the CPU 103 determines that the terminal apparatus 101 is to transmit the configuration information to the communication apparatus 151. Note that the result of this determination is referenced in step S708. In other words, the CPU 103 controls the connection information of the user-selected AP to be transmitted from the terminal apparatus 101 to the communication apparatus 151. The processing of this flowchart ends after step S1510.

In step S1511, the CPU 103 determines that the terminal apparatus 101 is not to transmit the configuration information to the communication apparatus 151. The result of this determination is referenced in step S708. In other words, the CPU 103 controls the connection information of the user-selected AP to not be transmitted from the terminal apparatus 101 to the communication apparatus 151. The processing of this flowchart ends after step S1511.

In step S1512, the CPU 103 determines that the terminal apparatus 101 is to transmit the configuration information to the communication apparatus 151. Note that the result of this determination is referenced in step S708. In other words, the CPU 103 controls the connection information of the user-selected AP to be transmitted from the terminal apparatus 101 to the communication apparatus 151. The processing of this flowchart ends after step S1512.

According to the present embodiment as described thus far, the setup app causes the terminal apparatus 101 to operate as follows. In the AP connection confirmation processing, the terminal apparatus 101 first attempts to make a connection between the terminal apparatus 101 and the user-selected AP. Then, if the connection between the terminal apparatus 101 and the AP fails, the terminal apparatus 101 determines whether the terminal apparatus 101 has previously connected to an AP that uses the predetermined authentication method. Through such a configuration, if the connection to the AP fails because the terminal apparatus 101 does not support the authentication method used by the user-selected AP, the connection information such as the password entered by the user can be assumed to be incorrect.

Additionally, according to the present embodiment, even if the terminal apparatus 101 has not previously connected to an AP that uses the predetermined authentication method (“no” in step S1504), whether it is possible that the terminal apparatus 101 supports the predetermined authentication method can be determined in steps S1505 and S1506.

Additionally, according to the present embodiment, the terminal apparatus 101 controls the display of the confirmation screen in accordance with the result of the determination made in steps S1505 and S1506. Accordingly, even if the connection to the user-selected AP fails, the terminal apparatus 101 can notify the user of the appropriate content regarding whether to transmit the configuration information.

### Fourth Embodiment

In the third embodiment, the terminal apparatus 101 has an OS that manages wireless profiles, and each wireless profile includes information indicating an authentication method. The setup app can obtain a wireless profile including information indicating an authentication method from the OS of the terminal apparatus 101. As a result, the CPU 103 determines whether there is a possibility that the terminal apparatus 101 supports the predetermined authentication method using the wireless profile in step S1506, for example. On the other hand, there are situations where the setup app cannot obtain a wireless profile including information indicating an authentication method from the OS. Specifically, for example, if the OS of the terminal apparatus 101 is macOS (registered trademark), the setup app cannot obtain a wireless profile including information indicating an authentication method from the OS of the terminal apparatus 101. The present embodiment will describe AP connection confirmation processing used in such a case. Note that the present embodiment is not limited to a configuration in which the setup app cannot obtain a wireless profile including information indicating an authentication method from the OS of the terminal apparatus 101. For example, the processing of the present embodiment may be executed even in a configuration in which the OS of the terminal apparatus 101 is Windows and the setup app can obtain a wireless profile including information indicating an authentication method from the OS of the terminal apparatus 101. When the processing according to the present embodiment is executed in a configuration where the OS of the terminal apparatus 101 is Windows, there is an advantage in that the processing can be completed more quickly than when the processing according to the third embodiment is executed.

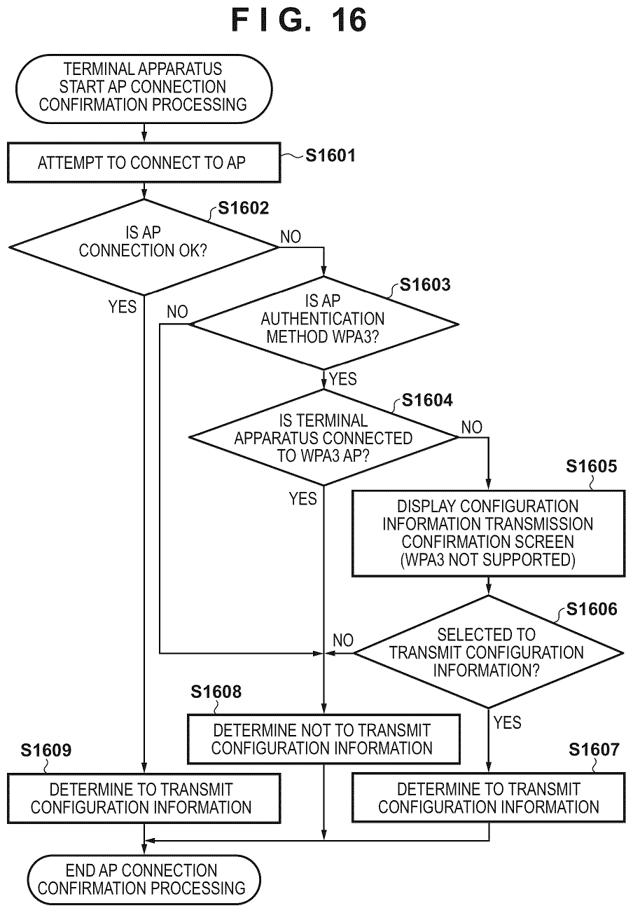

FIG. 16 is a flowchart illustrating AP connection confirmation processing executed by the terminal apparatus 101. This flowchart is implemented by the CPU 103 reading out a program stored in the ROM 104 into the RAM 105 and executing the program. Note that the present embodiment assumes that the terminal apparatus 101 executes the processing using the setup app. This flowchart corresponds to the processing performed in step S707.

The processing of steps S1601 to S1603 is similar to that of steps S1501 to S1503, and will therefore not be described.

In step S1604, the CPU 103 determines whether the terminal apparatus 101 has previously connected to an AP that uses the predetermined authentication method. The CPU 103 moves the sequence to step S1608 if a determination of “yes” is made, and to step S1605 if a determination of “no” is made. Note that the determination in step S1604 is made in the same manner as in step S1202, and will therefore not be described in detail.

In the third embodiment, when a determination of “no” was made in step S1504, the CPU 103 moved the sequence to step S1505, whereupon whether the version of the OS of the terminal apparatus 101 is at least a predetermined version was determined. When a determination of “yes” was made in step S1505, the sequence moved to step S1506, where the CPU 103 determined whether information indicating the predetermined authentication method was included in the wireless profile. However, in the present embodiment, as described above, although the terminal apparatus 101 has an OS that manages wireless profiles, each wireless profile does not include information indicating an authentication method. A determination such as that made in step S1506 cannot be made in such a terminal apparatus 101. Accordingly, in the present embodiment, when a determination of “no” is made in step S1604, the sequence moves to step S1605. This makes it possible to skip processing that uses the wireless profile when the wireless profile does not include information indicating the authentication method.

In step S1605, the CPU 103 displays the configuration information transmission confirmation screen, illustrated in FIG. 13B, on the display unit 108. When the user presses the button 1311 or the button 1312, the CPU 103 moves the sequence to step S1606.

In step S1606, the CPU 103 determines whether a button for transmitting the configuration information from the terminal apparatus 101 to the communication apparatus 151 has been selected. When the button 1311 is pressed, the CPU 103 makes a determination of “yes”, and moves the sequence to step S1607. On the other hand, when the button 1312 is pressed, the CPU 103 makes a determination of “no”, and moves the sequence to step S1608.

In step S1607, the CPU 103 determines that the terminal apparatus 101 is to transmit the configuration information to the communication apparatus 151. Note that the result of this determination is referenced in step S708. The processing of this flowchart ends after step S1607.

In step S1608, the CPU 103 determines that the terminal apparatus 101 is not to transmit the configuration information to the communication apparatus 151. The result of this determination is referenced in step S708. The processing of this flowchart ends after step S1608.

In step S1609, the CPU 103 determines that the terminal apparatus 101 is to transmit the configuration information to the communication apparatus 151. Note that the result of this determination is referenced in step S708. The processing of this flowchart ends after step S1609.

According to the present embodiment as described thus far, the setup app causes the terminal apparatus 101 to operate as follows. When the connection to the user-selected AP fails, the terminal apparatus 101 determines whether the terminal apparatus 101 has previously connected to an AP that uses the predetermined authentication method. If the terminal apparatus 101 is determined not to have previously connected to an AP that uses the predetermined authentication method (“no” in step S1604), the confirmation screen 1310 is displayed in the display unit 108. Such a configuration makes it possible to appropriately control whether the terminal apparatus 101 transmits the connection information, even if the OS of the terminal apparatus 101 is an OS that manages wireless profiles which do not include information indicating an authentication method.

### Other Embodiments

In the foregoing embodiments, when a determination of “yes” was made in step S309 (i.e., when the region 1011 was selected by the user), the CPU 103 moved the sequence to step S310, where the second determination processing was executed. However, the configuration is not limited thereto, and when a determination of “yes” is made in step S309, the CPU 103 may display a guide screen for the second setup without executing the second determination processing. In other words, if a determination of “yes” is made in step S309, the CPU 103 may execute step S312 without executing steps S310 and S311.

Additionally, in the aforementioned embodiments, the CPU 103 executed both the determination of step S406 and the determination of step S407 in the first determination processing. However, the configuration may be such that only one of these determinations is made. In other words, for example, in a configuration in which only the determination of step S406 is made, the CPU 103 may move the sequence to step S409, without executing the determination of step S407, when a determination of “yes” is made in step S405. The CPU 103 may also move the sequence to step S409 without executing the determination of step S407 when a determination of “no” is made in step S406. Additionally, for example, in a configuration in which only the determination of step S407 is made, the CPU 103 may move the sequence to step S410, without executing the determination of step S406, when a determination of “no” is made in step S405.

Additionally, in the aforementioned embodiments, the CPU 103 moved the sequence to step S308 when it was determined in step S304 that the first setup is not to be executed. However, the configuration is not limited thereto. For example, if the first setup is determined not to be executed in step S304, the CPU 103 may move the sequence to step S312 without executing steps S308 and S309. In other words, the CPU 103 may display a guide screen for the second setup when it is determined in the first determination processing that the first setup is not to be performed. Additionally, if the first setup is determined not to be executed in step S304, the CPU 103 may move the sequence to step S313 without executing steps S308 and S309. In other words, the CPU 103 may display a guide screen for the third setup when it is determined in the first determination processing that the first setup is not to be performed.

Additionally, in the aforementioned embodiments, in the first setup, the terminal apparatus 101 transmitted the configuration information to the communication apparatus 151 using the wireless communication unit 109. However, the configuration is not limited thereto. For example, the terminal apparatus 101 may transmit the configuration information to the communication apparatus 151 using the short-range wireless communication unit 110. In other words, the configuration information may be transmitted through BLE or Bluetooth communication between the terminal apparatus 101 and the communication apparatus 151. In this configuration, the wireless LAN connection between the terminal apparatus 101 and the AP need not be terminated in step S702. In other words, the wireless LAN connection between the terminal apparatus 101 and the AP may be maintained, and the terminal apparatus 101 may transmit the configuration information to the communication apparatus 151 using the short-range wireless communication unit 110.

According to the present disclosure, it is possible to provide a technique for an information processing apparatus to appropriately perform processing pertaining to connection information for an AP.

It goes without saying that the present disclosure can also be achieved by supplying, to a system or apparatus, a recording medium having recorded thereon the program code for software that realizes the functions of the aforementioned embodiments, and a computer (or CPU or MPU) of the system or apparatus reading out and executing the program code recorded on the recording medium. In this case, program code itself that is loaded from the storage medium realizes the functions of the foregoing embodiments, and the storage medium that stores the program code constitutes the present disclosure.

Examples of the storage medium that can be used to supply the program code include flexible disks, hard disks, optical disks, magneto-optical disks, CD-ROMs, CD-Rs, magnetic tape, non-volatile memory cards, ROMs, DVDs, and the like.

Additionally, it goes without saying that the functions of the foregoing embodiments are implemented not only by the computer executing the read-out program code, but also when an operating system (OS) or the like running on the computer performs part or all of the actual processing on the basis of instructions in the program code, and the functions of the aforementioned embodiments are realized through that processing.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-167828, filed Sep. 26, 2024 which is hereby incorporated by reference herein in its entirety.

What is claimed is:

1. A non-transitory computer-readable storage medium storing a program configured to cause a computer of an information processing apparatus to function as:
an obtaining unit configured to obtain first connection information for connecting to an external first access point different from the information processing apparatus;
a first determining unit configured to, in a case where the first connection information is obtained by the obtaining unit and an authentication method of the first access point is a predetermined authentication method, determine whether the information processing apparatus has previously connected to an access point that uses the predetermined authentication method; and
a first attempting unit configured to, in a case where the first determining unit has determined that the information processing apparatus has previously connected to an access point that uses the predetermined authentication method, attempt a connection between the information processing apparatus and the first access point based on the first connection information obtained by the obtaining unit.

2. The non-transitory computer-readable storage medium according to claim 1,
wherein the program is configured to cause the computer to further function as a control unit configured to, in a case where the connection between the information processing apparatus and the first access point is successful as a result of the attempt by the first attempting unit, transmit the first connection information from the information processing apparatus to a communication apparatus.

3. The non-transitory computer-readable storage medium according to claim 1,
wherein the program is configured to cause the computer to further function as a storage unit configured to store information indicating authentication methods of access points to which the information processing apparatus has previously connected, and
the first determining unit determines that the information processing apparatus has previously connected to an access point that uses the predetermined authentication method in a case where information indicating the authentication method is stored in the storage unit.

4. The non-transitory computer-readable storage medium according to claim 1,
wherein the program is configured to cause the computer to further function as:
a second determining unit configured to, in a case where the first determining unit has determined that the information processing apparatus has not previously connected to an access point that uses the predetermined authentication method, determine whether there is a possibility that the information processing apparatus supports the predetermined authentication method; and
a second attempting unit configured to, in a case where the second determining unit has determined that there is the possibility, attempt a connection between the information processing apparatus and the first access point based on the first connection information obtained by the obtaining unit.

5. The non-transitory computer-readable storage medium according to claim 4,
wherein the second determining unit determines that there is the possibility in a case where information indicating the predetermined authentication method is held in a wireless profile of the information processing apparatus.

6. The non-transitory computer-readable storage medium according to claim 5,
wherein the second determining unit determines that there is the possibility in a case where a version of an OS of the information processing apparatus is at least a predetermined version and information indicating the predetermined authentication method is held in the wireless profile.

7. The non-transitory computer-readable storage medium according to claim 4,
wherein the program is configured to cause the computer to further function as an accepting unit configured to be capable of accepting a user selection as to whether to transmit the first connection information to a communication apparatus in a case where the connection by the second attempting unit fails.

8. The non-transitory computer-readable storage medium according to claim 1,
wherein the obtaining unit obtains the first connection information through an interface capable of accepting a user input of connection information for connecting to the access point.

9. The non-transitory computer-readable storage medium according to claim 1,
wherein the predetermined authentication method is one of WPA3-SAE, WPA2-WPA3 Mix-PSK, and WPA3-EAP.

10. A non-transitory computer-readable storage medium storing a program configured to cause a computer of an information processing apparatus to function as:
an obtaining unit configured to obtain first connection information for connecting to an external first access point different from the information processing apparatus;
an attempting unit configured to, in a case where the first connection information is obtained by the obtaining unit, attempt a connection between the information processing apparatus and the first access point based on the first connection information; and
a first determining unit configured to, in a case where the attempt by the attempting unit fails and an authentication method of the first access point is a predetermined authentication method, determine whether the information processing apparatus has previously connected to an access point that uses the predetermined authentication method.

11. The non-transitory computer-readable storage medium according to claim 10,
wherein the program is configured to cause the computer to further function as a control unit configured to, in a case where the first determining unit has determined that the information processing apparatus has previously connected to an access point that uses the predetermined authentication method, control the first connection information not to be transmitted from the information processing apparatus to a communication apparatus.

12. The non-transitory computer-readable storage medium according to claim 10,
wherein the program is configured to cause the computer to further function as a storage unit configured to store information indicating authentication methods of access points to which the information processing apparatus has previously connected, and
the first determining unit determines that the information processing apparatus has previously connected to an access point that uses the predetermined authentication method in a case where information indicating the authentication method is stored in the storage unit.

13. The non-transitory computer-readable storage medium according to claim 10,
wherein the program is configured to cause the computer to further function as an accepting unit capable of accepting a user selection as to whether to transmit the first connection information to a communication apparatus, in a case where the first determining unit has determined that the information processing apparatus has not previously connected to an access point that uses the predetermined authentication method.

14. The non-transitory computer-readable storage medium according to claim 10,
wherein the program is configured to cause the computer to further function as a second determining unit configured to, in a case where the first determining unit has determined that the information processing apparatus has not previously connected to an access point that uses the predetermined authentication method, determine whether there is a possibility that the information processing apparatus supports the predetermined authentication method.

15. The non-transitory computer-readable storage medium according to claim 14,
wherein the second determining unit determines that there is the possibility in a case where information indicating the predetermined authentication method is held in a wireless profile of the information processing apparatus.

16. The non-transitory computer-readable storage medium according to claim 15,
wherein the second determining unit determines that there is the possibility in a case where a version of an OS of the information processing apparatus is at least a predetermined version and information indicating the predetermined authentication method is held in the wireless profile.

17. The non-transitory computer-readable storage medium according to claim 10,
wherein the obtaining unit obtains the first connection information through an interface capable of accepting a user input of connection information for connecting to the access point.

18. The non-transitory computer-readable storage medium according to claim 10,
wherein the predetermined authentication method is one of WPA3-SAE, WPA2-WPA3 Mix-PSK, and WPA3-EAP.

19. An information processing apparatus comprising at least one memory and at least one processor which function as:
an obtaining unit configured to obtain first connection information for connecting to an external first access point different from the information processing apparatus;
a first determining unit configured to, in a case where the first connection information is obtained by the obtaining unit and an authentication method of the first access point is a predetermined authentication method, determine whether the information processing apparatus has previously connected to an access point that uses the predetermined authentication method; and
a first attempting unit configured to, in a case where the first determining unit has determined that the information processing apparatus has previously connected to an access point that uses the predetermined authentication method, attempt a connection between the information processing apparatus and the first access point based on the first connection information obtained by the obtaining unit.

20. A method for controlling an information processing apparatus, the method comprising:
obtaining first connection information for connecting to an external first access point different from the information processing apparatus;
in a case where the first connection information is obtained and an authentication method of the first access point is a predetermined authentication method, determining whether the information processing apparatus has previously connected to an access point that uses the predetermined authentication method; and
in a case where the information processing apparatus is determined to have previously connected to an access point that uses the predetermined authentication method, attempting a connection between the information processing apparatus and the first access point based on the first connection information obtained.

21. An information processing apparatus comprising at least one memory and at least one processor which function as:
an obtaining unit configured to obtain first connection information for connecting to an external first access point different from the information processing apparatus;
an attempting unit configured to, in a case where the first connection information is obtained by the obtaining unit, attempt a connection between the information processing apparatus and the first access point based on the first connection information; and
a first determining unit configured to, in a case where the attempt by the attempting unit fails and an authentication method of the first access point is a predetermined authentication method, determine whether the information processing apparatus has previously connected to an access point that uses the predetermined authentication method.

22. A method for controlling an information processing apparatus, the method comprising:
obtaining first connection information for connecting to an external first access point different from the information processing apparatus;
in a case where the first connection information is obtained, attempting a connection between the information processing apparatus and the first access point based on the first connection information; and
in a case where the attempt fails and an authentication method of the first access point is a predetermined authentication method, determining whether the information processing apparatus has previously connected to an access point that uses the predetermined authentication method.
